(19) United States
(12) Patent Application Publication
(10) Pub. No.: US 2020/0318594 A1
(43) Pub. Date: Oct. 8, 2020

(54) FLUID INJECTOR NOZZLE WITH SWIRL CHAMBER

(71) Applicant: 3M INNOVATIVE PROPERTIES COMPANY, St. Paul, MN (US)

(72) Inventors: Scott M. Schnobrich, Stillwater, MN (US); Barry S. Carpenter, Oakdale, MN (US); Michael E. Nelson, Woodbury, MN (US)

(21) Appl. No.: 16/769,601

(22) PCT Filed: Dec. 20, 2018
(86) PCT No.: PCT/US2018/066733

§ 371 Date: Jun. 4, 2020

Related U.S. Application Data
(60) Provisional application No. 62/609,020, filed on Dec. 21, 2017.

(51) Int. Cl. F02M 61/16; F02M 61/18

(52) U.S. Cl. CPC F02M 61/162; F02M 61/1853

(57) ABSTRACT

A nozzle (100) comprising an inlet face (12) on an inlet side, an outlet face (12) on an outlet side, a thickness between said inlet face and said outlet face, and a swirl chamber (20) located within said thickness, with said swirl chamber comprising a bottom surface (22) and an outer side wall (28) extending from said bottom surface toward said outlet side so as to form an outer periphery of an outlet opening (24) of said swirl chamber on said outlet face, and at least one feeder through-hole (30) having an inlet opening (32) on said inlet face and an outlet opening that opens into said swirl chamber so as to direct a fluid, flowing through said at least one feeder through-hole, to flow around a central axis (11) of said swirl chamber, along said outer side wall and within said swirl chamber.

The present invention relates to fluid (e.g., liquid or gaseous fuel) injectors, in particular with a fluid (e.g., a liquid or gaseous fuel) injector nozzle, more particularly with a fluid injector nozzle structure or component (e.g., a nozzle plate, a monolithic nozzle plate and valve guide, or an assembled nozzle plate and valve guide) having a fluid injection supply port that includes a swirl chamber and at least one feeder through-hole that provides fluid communication into the swirl chamber, methods of making the same, and methods of using the same.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Fuel injection has become the preferred method of fuel delivery in the combustion chambers of internal combustion (IC) engines, thus minimizing the demand or need for carburetor-based systems. In a fuel injected system, the fuel injector nozzle is intended to deliver the fuel into the combustion chamber in the form of a spray pattern or plume of droplets that provide the appropriate air/fuel mixture in the combustion process for optimal engine performance and engine lifetime. Conventional fuel injector nozzle designs, however, can fail to exhibit the versatility to provide such a fuel spray pattern or plume. For example, the fuel may not be capable of breaking up into an optimum droplet size and distribution pattern or plume at an optimum distance from the nozzle, within the confines of the combustion chamber. In addition, the nozzle may not consistently produce the optimum droplet size and distribution pattern or plume during every injection event. A poorly formed fuel spray pattern or plume, or the inconsistent formation thereof, can lead to incomplete combustion, which in turn leads to higher emissions, lower fuel economy, and the build-up of combustion byproducts (e.g., coking) within the combustion chamber of the engine.

### SUMMARY OF THE INVENTION

There are fuel injectors (e.g., piezoelectric actuated fuel injectors) that can produce a cone-shaped fuel spray plume or pattern (e.g., U.S. Pat. No. 6,420,817). Such fuel spray shapes can be desirable, but the injectors used to make such plumes can be very complicated and expensive. Such fuel injectors can also fail so that their nozzles remain open (i.e., do not close) during the entire combustion cycle. A desirable objective of the present invention is to provide a fuel injector nozzle design that can exhibit one or any combination of the following attributes: reduce the cost of producing a cone-shaped fuel plume, consistently produce the same cone-shaped fuel plume, not fail in the open position, and be modifiable to produce a wide variety of cone-shaped fuel spray plumes.

The present invention provides a new fluid supply or injector nozzle structure (e.g., in the form of a monolithic nozzle plate, a monolithic nozzle plate and valve guide, or an assembled nozzle plate and valve guide) having at least one fluid injection supply port or through-hole. The fluid injection supply port comprises a swirl chamber having at least one outlet opening on an outlet face of an outlet side of the nozzle structure and one or more feeder through-holes that provide fluid communication into the swirl chamber from an inlet face on an inlet side of the nozzle structure.

In one or more embodiments, each feeder through-hole opening into a swirl chamber is configured to direct the fluid flowing through the feeder through-hole to swirl or otherwise flow along an outer side wall of the swirl chamber, where the outer side wall is located around an axis (e.g., a central axis that could also be a normal axis) of the swirl chamber. The outlet opening of the feeder through-hole opens into the swirl chamber such that a fluid flowing through the feeder through-hole and out of the outlet opening of the swirl chamber is directed to flow around the swirl chamber axis at least while the fluid is within the swirl chamber.

In one or more embodiments, fluid (e.g., a liquid fuel) exiting the swirl chamber can consistently breakup into droplets at a desired distance from the outlet opening of the swirl chamber and the droplets breakup into a desired average droplet size, droplet distribution, and droplet pattern or plume. The spray patterns and breakup distances provided by one or more embodiments of the present invention can, when used in fuel injection systems for combustion engines, improve the combustion characteristics of the delivered fuel, which in turn can lead to one or any combination of lower emissions, improved fuel economy, and reduced build-up of byproducts within an internal combustion (“IC”) engine.

It can be advantageous to have a repeatable spray pattern or plume, in addition to maintaining a particular optimum droplet size and distribution, from one injection event to the next. In an internal combustion engine, e.g., it can be desirable to have smaller droplets, because reducing the droplet size can increase the overall droplet surface area, which reduces the fuel available for quenching the fuel's burning and can allow the droplets to evaporate faster and burn more completely, inside the combustion chamber of the internal combustion engine. A more complete burn allows the engine to run at a lower equivalence ratio, or leaner, which means less fuel can needed for each fuel injection and combustion event or cycle, thereby improving the fuel efficiency of the IC engine.

The droplet size can also affect the depth of penetration of the fuel from the nozzle into the combustion chamber, or the penetration distance of the fuel from the nozzle outlet face or surface, for a given combustion cycle or event. The fuel droplet size can be affected by the geometry of the through-hole cavity, independent of the pressure of the supplied fuel. The penetration distance can be affected by the flow rate of the fuel as it exits the nozzle through-hole. The flow rate of the exiting fuel can be affected by the geometry of the through-hole cavity, independent of the pressure of the supplied fuel. Adjusting the through-hole cavity geometry to adjust the penetration distance of each fuel stream, the size of the fuel droplets in each fuel stream, or both, can be used to change the shape of (e.g., spread-out) the overall fuel pattern formed by the individual through-hole fuel stream(s) exiting the fuel injector nozzle. This technique can allow for more efficient mixing of the fuel with the fresh air charge (i.e., the amount of fresh air being supplied into the combustion chamber for each combustion event). Although not wishing to be bound by theory, the exemplary nozzle structures incorporating one or more fuel injection supply ports with a swirl chamber and one or more feeder through-holes, as described herein, may provide particular advantages in both droplet size distribution and spray pattern not provided in a cost-effective manner by existing injection systems. For example, it is theorized that the angular momentum provided to a fluid (i.e., a liquid or gas fuels) by the combination of a swirl chamber and feeder through-hole(s) in the nozzle structure, as described herein, can cause the fluid to form a selected cone-shaped spray pattern upon exit from the swirl chamber. In addition, the transverse shear forces in the fluid can cause droplets to form having an advantageous size distribution after the fluid exits the swirl chamber.

The addition of a counterbore at the outlet of a swirl chamber of a nozzle structure as described herein may, in one or more embodiments, provide additional control over the height of the swirl chamber and/or the feeder through-hole(s) within a nozzle structure as described herein and may, therefore, provide further control over the fluid (e.g., fuel) droplet size distribution and spray pattern.

These and other aspects, features and/or advantages of the invention may be shown and described in the drawings and detailed description herein, where like reference numerals are used to represent similar parts. It is to be understood, however, that the drawings and description are for illustration purposes only and should not be read in a manner that would unduly limit the scope of this invention.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWING

In the accompanying drawing:

FIG. 1A is a cross-sectional view of one illustrative embodiment of a nozzle including a nozzle plate having a swirl chamber and one or more feeder through-holes as described herein, with a schematic cone-shaped spray plume or pattern.

FIG. 1B is a cross-sectional view of another illustrative embodiment of a nozzle, designed for use with a different valve and valve guide, that includes a nozzle plate having a supply port comprising a swirl chamber and one or more feeder through-holes as described herein.

FIG. 1C is an enlarged cross-sectional view of a portion of the nozzle plate 10 including a supply port comprising the swirl chamber 20 and feeder through-holes 30 as described herein.

FIG. 1D is an enlarged cross-sectional view of a portion of the nozzle plate 10 taken along line 1D-1D in FIG. 1C.

FIG. 2A is a perspective view of a negative image of an exemplary supply port comprising a swirl chamber that can be used in any nozzle structure, and includes a plurality of feeder through-holes leading into the swirl chamber.

FIG. 2B is a top plan view taken along axis 11 with axes 31 depicted to illustrate an exemplary relationship between the direction of flow from feeder through-holes 30 into a swirl chamber 20 for any nozzle structure.

FIG. 2C is a schematic diagram provided to illustrate an exemplary relationship between the direction of flow from feeder through-holes 30 into a swirl chamber 20 relative to central axis 11 and one of the through-hole axes 31.

FIG. 3A is a schematic diagram depicting one illustrative embodiment of through-hole axis directed at both an inner side wall and an outer side wall of one illustrative embodiment of a swirl chamber as described herein.

FIG. 3B is a schematic diagram depicting one illustrative embodiment of through-hole axis directed at an outer side wall of one illustrative embodiment of a swirl chamber as described herein.

FIGS. 4A-D are plan views of an outlet face including illustrative alternative embodiments of swirl chambers that may be provided in any nozzle structures as described herein.

FIG. 5A is a plan view of an outlet face including multiple swirl chambers on a single nozzle plate.

FIG. 5B is a cross-sectional view of the nozzle plate of FIG. 5A taken along line 5B-5B in FIG. 5A.

FIG. 6 is an enlarged cross-sectional view of another illustrative embodiment of a nozzle plate including a swirl chamber having a counterbore at its outlet as described herein.

FIGS. 7-18 are perspective views of negative images of illustrative embodiments of supply ports comprising swirl chambers including a plurality of feeder through-holes that may be used in any nozzle structures as described herein.

FIG. 19 is a perspective view of a schematic representation of one illustrative embodiment of a funnel-shaped plume that may be formed using a swirl chamber in a nozzle structure as described herein.

FIG. 20 is a side view of the funnel-shaped plume of FIG. 19 illustrating the angle θ between opposing sides or edges of the plume.

FIGS. 21-24 depict top, bottom, side and cross-sectional views of one alternative illustrative embodiment of a nozzle plate having a supply port comprising a swirl chamber and at least one feeder through-hole as described herein.

FIGS. 25-28 are cross-sectional views of alternative illustrative embodiments of swirl chambers that may be provided in a nozzle plate as described herein.

FIGS. 29-30 are cross-sectional views of other alternative illustrative embodiments of swirl chambers that may be provided in a nozzle plate as described herein.

FIG. 31 it is a top plan view of another alternative embodiment of a nozzle plate as described herein.

FIG. 32 is a cross-sectional view of a portion of the nozzle plate of FIG. 31, taken along line 32-32 in FIG. 31.

FIG. 33 it is a cross-sectional view of a portion of the nozzle plate of FIG. 31, taken along line 33-33 in FIG. 31.

FIGS. 34A-34C are a side view, top view and bottom view, respectively, of a negative image supply port according to one embodiment of the present invention, with a swirl chamber and multiple feeder through-holes.

FIG. 34D is a an enlarged cross-sectional view of only the swirl chamber of the supply port of FIGS. 34A-34C.

FIG. 34E is an enlarged side view of one of the feeder through-holes shown in FIGS. 34A-34C.

FIGS. 35A-35C are a side view, top view and bottom view, respectively, of a negative image supply port according to another embodiment of the present invention, with a swirl chamber and multiple feeder through-holes.

FIG. 35D is an enlarged side view of one of the feeder through-holes shown in FIGS. 35A-35C.

FIGS. 36A-36C are a side view, top view and bottom view, respectively, of a negative image supply port according to a different embodiment of the present invention.

FIGS. 37A-37C are a side view, top view and bottom view, respectively, of a negative image supply port according to another embodiment of the present invention. FIGS. 38A-38C are a side view, top view and bottom view, respectively, of a negative image supply port according to a different embodiment of the present invention.

FIG. 38D is an enlarged cross-sectional view of only the swirl chamber of the supply port of FIGS. 38A-38C.

FIGS. 39A-39C are a side view, top view and bottom view, respectively, of a negative image supply port according to another embodiment of the present invention.

FIG. 39D is an enlarged cross-sectional view of only the swirl chamber of the supply port of FIGS. 39A-39C.

FIGS. 40A-40C are a side view, top view and bottom view, respectively, of a negative image supply port according to one embodiment of the present invention.

FIG. 40D is an enlarged cross-sectional view of only the swirl chamber of the supply port of FIGS. 40A-40C.

FIGS. 41A-41C are a side view, top view and bottom view, respectively, of a negative image supply port according to another embodiment of the present invention.

### DETAILED DESCRIPTION OF CERTAIN EMBODIMENTS

In describing illustrative embodiments of the invention, specific terminology is used for the sake of clarity. The invention, however, is not intended to be limited to the specific terms so selected, and each term so selected includes all technical equivalents that operate similarly.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a nozzle structure that comprises “a” through-hole can be interpreted to as “one or more” through-holes.

The term “and/or” means one or all of the listed elements or a combination of any two or more of the listed elements.

As used herein, the term “or” is generally employed in its sense including “and/or” unless the content clearly dictates otherwise.

Also herein, the recitations of numerical ranges by endpoints include all numbers subsumed within that range in increments of 0.001 (e.g., a range of from 1 to 5 includes 1.000, 1.001, 1.002, etc., 1.100, 1.101, 1.102, etc., 2.000, 2.001, 2.002, etc., 2.100, 2.101, 2.102, etc., 3.000, 3.001, 3.002, etc., 3.100, 3.101, 3.102, etc., 4.000, 4.001, 4.002, etc., 4.100, 4.101, 4.102, etc., 5.000, 5.001, 5.002, etc.) and any range within that range, unless expressly indicated otherwise.

The nozzle structures and nozzles incorporating the nozzle structures described herein can, in one or more embodiments, be made using any suitable additive manufacturing techniques (i.e., processes and equipment). Such additive manufacturing techniques may include, for example, the use of single photon, multiphoton, or other net-shape technology. Such additive manufacturing techniques that can be used include, for example, multiphoton (e.g., two photon) techniques, equipment and materials as described, e.g., in U.S. Pat. No. 9,333,598 B2 and U.S. Patent Application Publication No. US 2013/0313339 (both titled “Nozzle and Method of Making Same”), which is incorporated herein by reference in its entirety. Methods of manufacturing the nozzle structures and nozzles incorporating the nozzle structures described herein may also be described in the following co-pending applications: METHOD OF ELECTROFORMING MICROSTRUCTURED ARTICLES, International Patent Application No. PCT/M2017/058299, based on U.S. Provisional Application No. 62/438,567, filed on Dec. 23, 2016; NOZZLE STRUCTURES WITH THIN WELDING RINGS AND FUEL INJECTORS USING THE SAME, International Application Number PCT/M2017/058168, based on U.S. Provisional Application No. 62/438,558, filed on Dec. 23, 2016; and MAKING NOZZLE STRUCTURES ON A STRUCTURED SURFACE, International Application Number PCT/IB2017/058315, based on U.S. Provisional Application No. 62/438,561, filed on Dec. 23, 2016, which are each incorporated herein by reference in its entirety.

In one embodiment, multiphoton additive manufacturing processes, equipment and other technology can be used to fabricate various microstructured features, which can include one or more hole forming features that may be used in one or more nozzle structures incorporated to form at least part of a nozzle such as, for example, those used in fuel injectors. Such features can be used to form nozzle structures (or other articles) themselves, they can be used to form intermediate molds that are useful in fabricating nozzle structures (or other articles), or they can be used to form both. Other suitable additive manufacturing process(es) (e.g., electroplating, metal particle sintering, and other additive metal manufacturing processes) can be used with the microstructured feature(s) to form the nozzle structures (or other articles) and intermediate molds. The nozzle structures described herein (e.g., nozzle plates) and any other nozzle structures according to the present invention (e.g., nozzle plates, valve guides formed integrally with a nozzle plate, etc.) may be constructed of any material or materials suitable for use in a nozzle application (e.g., a nozzle for a fuel injector), such as one or more metals, metal alloys, ceramics, etc. In particular, electroplatable metals and metal alloys can be desirable (e.g., nickel, nickel-cobalt, nickel-manganese, or other nickel-based alloys).

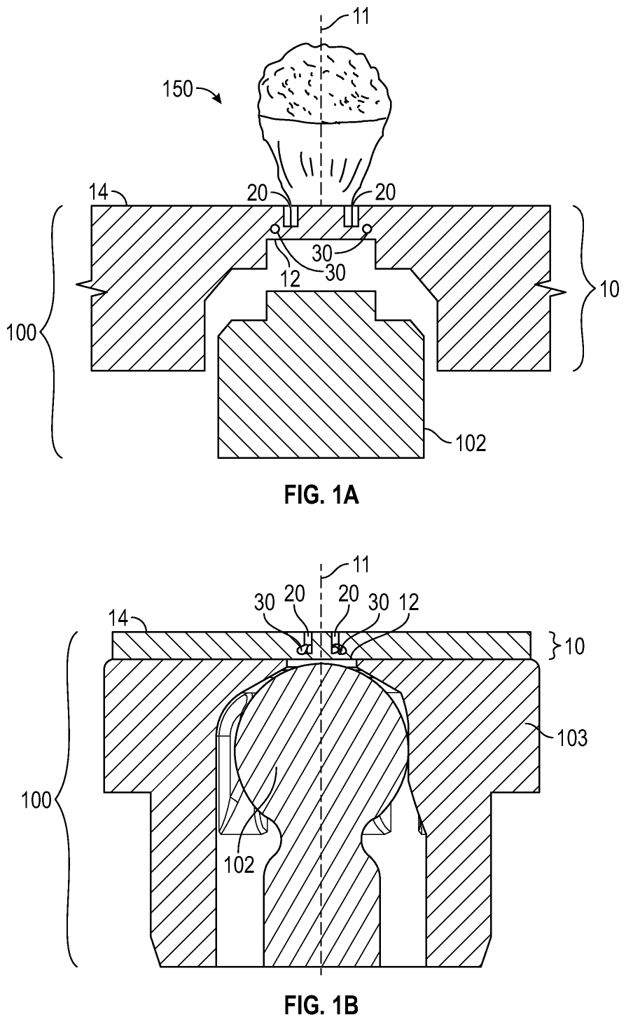

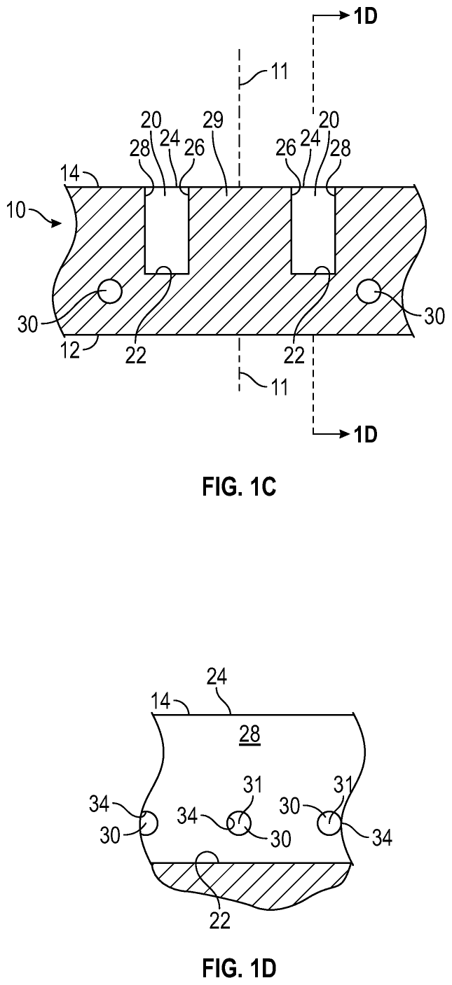

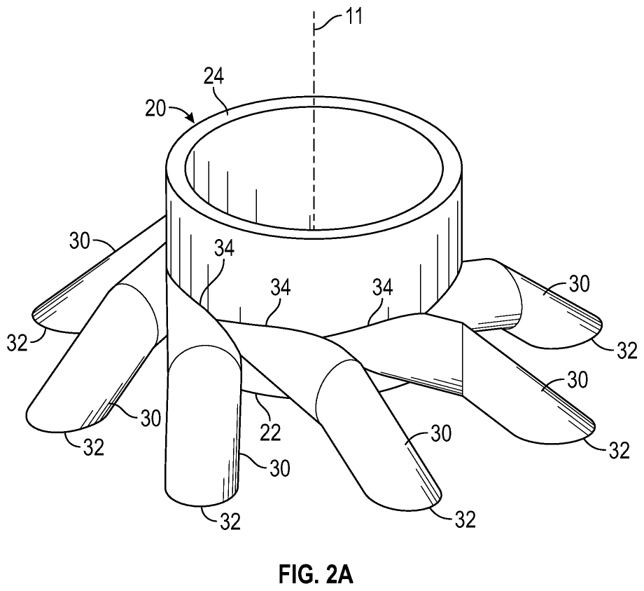

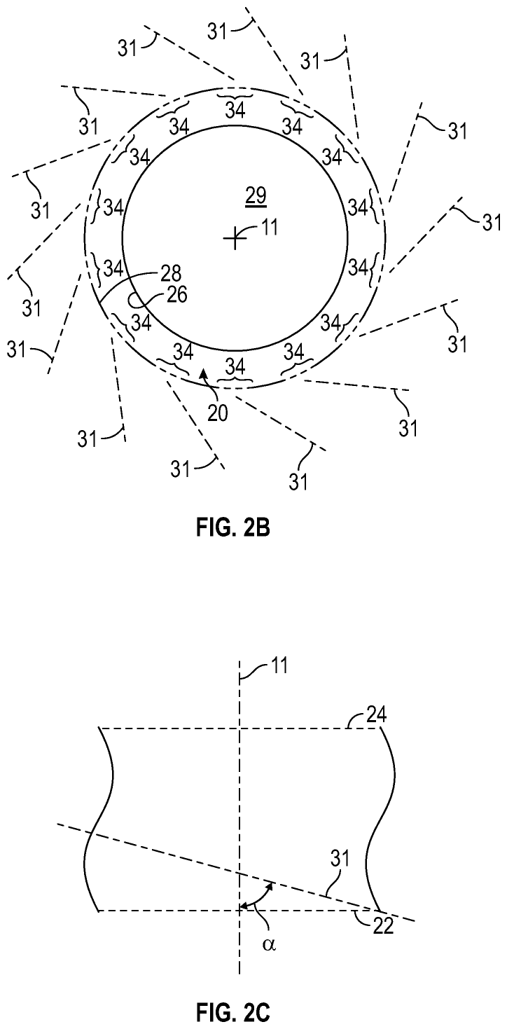

FIGS. 1A, 1B and 1C depict one illustrative embodiment of a nozzle 100 incorporating one illustrative embodiment of a nozzle structure, plate 10 as described herein. The nozzle 100 includes a valve 102 positioned in a valve guide that is formed integrally with the nozzle plate (both identified by reference number 10 in FIG. 1A). Alternatively, as shown in FIG. 1B, the nozzle plate and valve guide can be two separate components (reference number 10 and 103, respectively) that are secured to each other (e.g., via welding). Movement of the valve 102 within a cavity formed by the valve guide towards and away from the inlet surface or face 12 of the nozzle plate 10 provides for delivery of liquid or gaseous fluid (e.g., a fuel such as gasoline, diesel fuel, fuel oil, alcohol, methane, butane, natural gas, etc.) which passes through the feeder through-holes 30 and swirl chamber 20 of nozzle plate 10.

Fluid passing through the feeder through-holes 30 into swirl chamber 20 exits swirl chamber 20 in a desired spray pattern of fluid streams to form a fluid plume., one illustrative example of which is depicted as spray pattern or plume 150 in FIG. 1A. The spray pattern or plume 150 is preferably formed around a central axis 11. In one or more embodiments, the spray pattern or plume may define the central axis which may, in one or more embodiments, be described as being formed within a center of the spray pattern or plume formed by multiple fluid streams exiting the swirl chamber in a nozzle plate as described herein. The center of the spray pattern or plume can be defined by the center of the volume occupied by the droplets forming the spray pattern or plume in the direction along which the fluid moves. It can be desirable for swirl chamber to be formed so that the central axis 11 extends through a center of the swirl chamber and parallel to the outer side wall, the inner side wall if it has one, or both the inner and outer side walls if it has both.

The nozzle plate 10 includes an inlet surface or face 12 on an inlet side facing the valve 102 and an outlet surface or face 14 on an outlet side of the nozzle plate 10 which is on an opposite side of the nozzle plate from the inlet face 12. The nozzle plate 10 defines a thickness between the inlet face 12 and the outlet face 14 in the area occupied by the swirl chamber 20 and feeder through-holes 30. Referring to, e.g., FIG. 1C, swirl chamber 20 is located within that thickness and defined at least in part by a bottom surface 22 having a periphery and an outer side wall 28 located along the periphery of the bottom surface 22 and extending from the bottom surface 22 toward the outlet face 14. As a result, the outer side wall 28 forms an outer periphery of an outlet opening 24 of the swirl chamber 20 on the outlet face 14. Fluid exiting the swirl chamber 20 passes through the outlet opening 24 of the swirl chamber 20 on the outlet face 14.

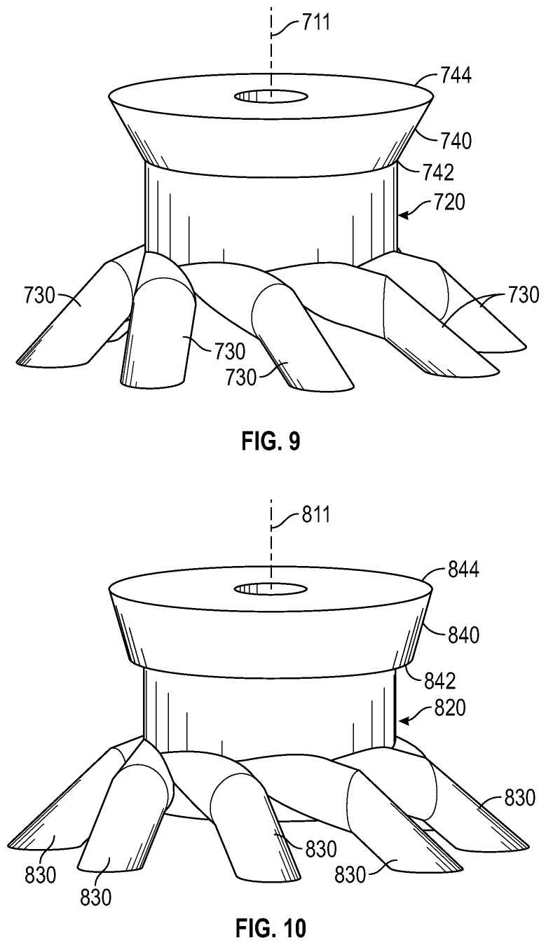

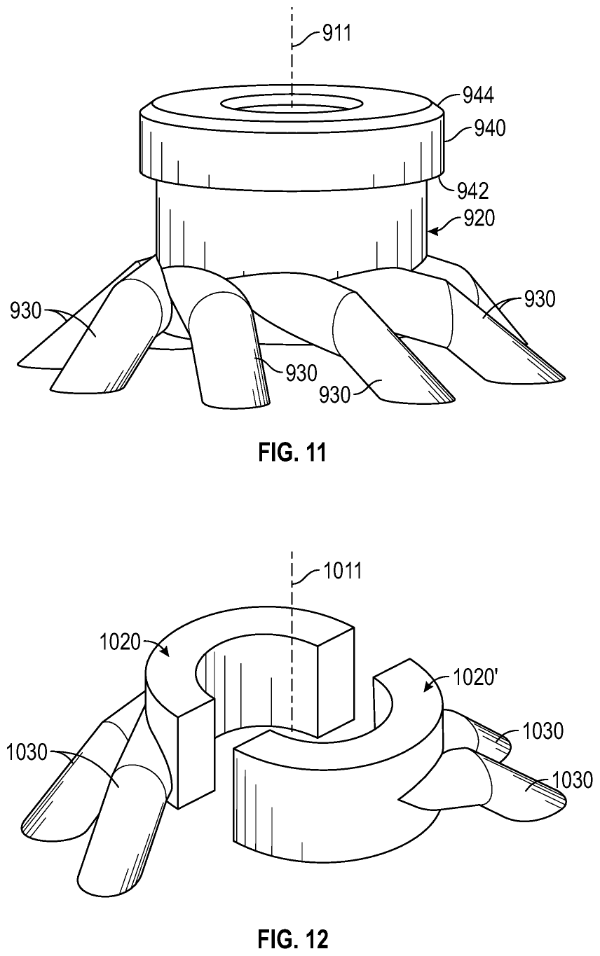

In the depicted illustrative embodiment of swirl chamber 20, the swirl chamber is provided in the form of an annular ring-shaped groove and, as such, includes an inner side wall 26 facing the outer side wall 28. The inner side wall 26 extends from the bottom surface 22 of the swirl chamber 20 toward the outlet face 14 and also forms an inner periphery of the outlet opening 24 of the swirl chamber 20 on the outlet face 14. The portion of the nozzle structure that defines, at least in part, the inner side wall 26 of the swirl chamber 20 can be referred to as a central land or island portion 29. This central land or island portion 29 can be seen as partially filling a blind hole swirl chamber, such as those swirl chambers 320, 420 and 1920 shown in FIGS. 5, 6 and 25-28 respectively. The illustrative embodiment of nozzle plate 10 depicted in FIGS. 1A and 1C also includes a plurality of feeder through-holes 30 used to supply a fluid to the swirl chamber 20. FIG. 1D, taken along line 1D-1D in FIG. 1C, depicts the outer side wall 28 of swirl chamber 20 as extending from the bottom surface 22 to outlet face 14 which, in the depicted view, also forms outlet opening 24 of swirl chamber 20. A plurality of outlet openings 34 of a plurality of feeder through-holes 30 are seen in outer side wall 28 along with their respective through-hole axes 31.

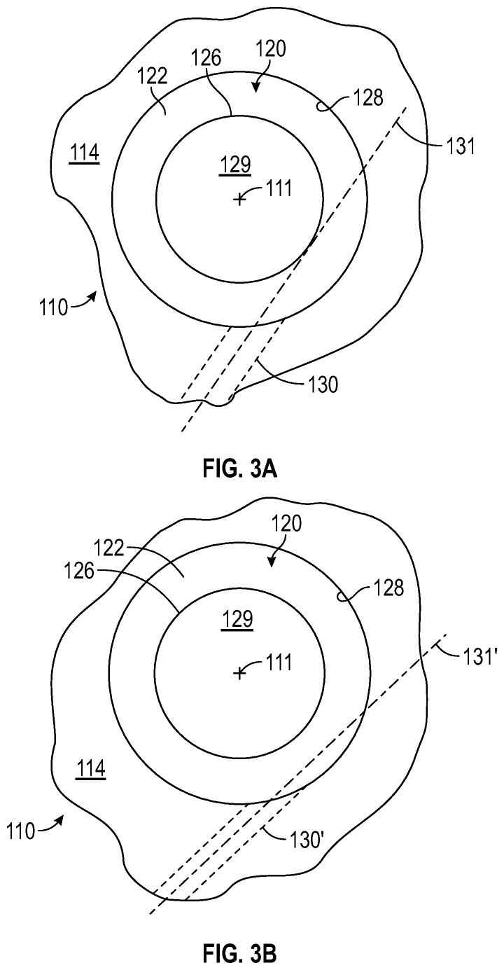

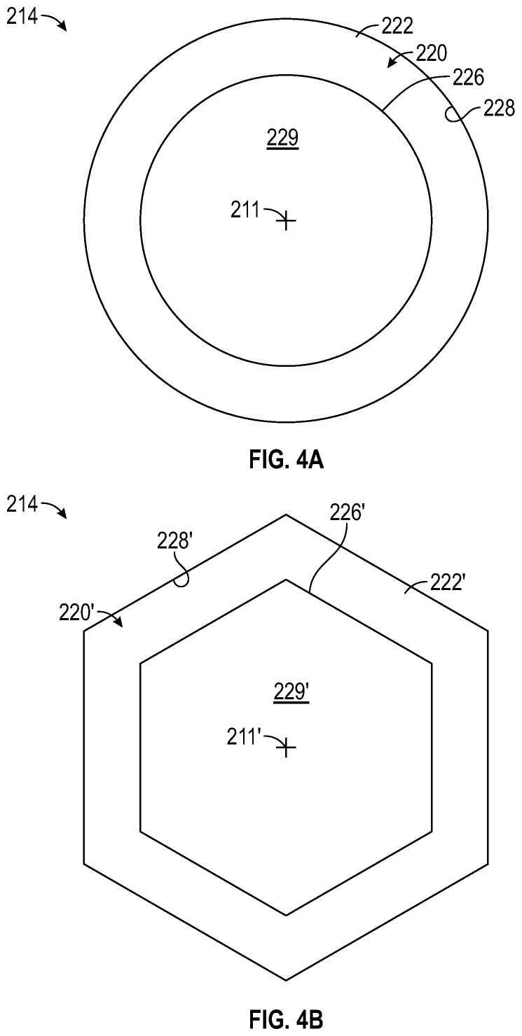

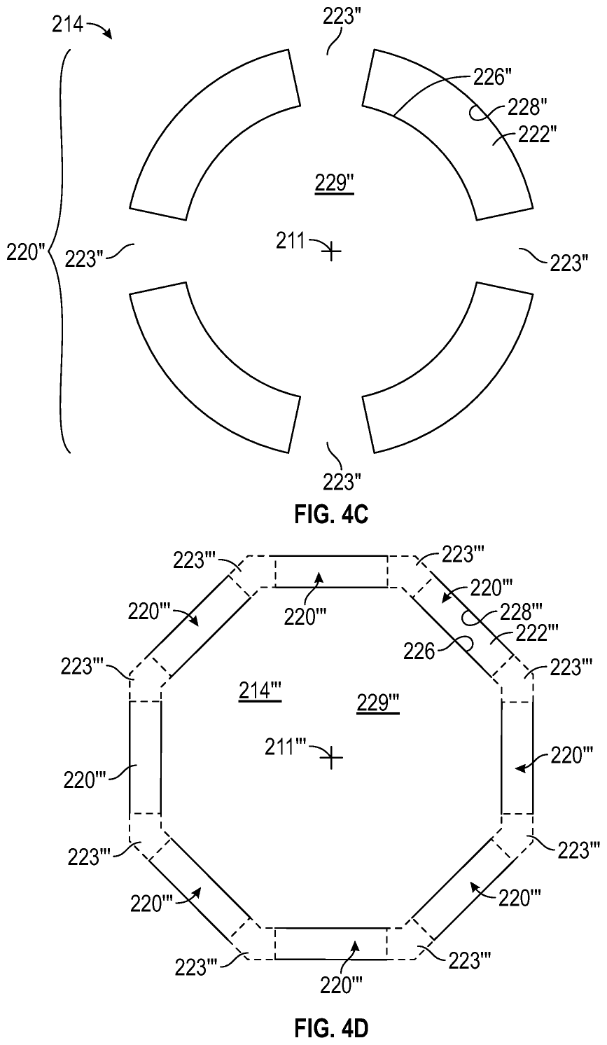

FIG. 2A is a perspective view of a negative image of one embodiment of the swirl chamber 20 and feeder through-holes 30 that could be formed in the nozzle plate 10 of

FIGS. 1A and 1C-1D or any other nozzle structure. In other words, the features depicted as solid in FIG. 2A actually correspond to the voids formed in the nozzle structure (e.g., plate 10), through which fluids (liquids or gases) flow during an injection event. The use of a negative image as seen in FIG. 2A is helpful to visualize the feeder through-holes and swirl chambers formed in the nozzle structures of the present invention (e.g., plate 10).

In particular, each of the feeder through-holes 30 includes an inlet opening 32 on the inlet face 12 of the nozzle structure (e.g., plate 10) and an outlet opening 34 that opens into the swirl chamber 20. As a result, each of the feeder through-holes 30 is used to direct a fluid flowing through the feeder through-hole 32 swirl or otherwise flow around the swirl chamber 20. In particular, the feeder through-holes 30 may be arranged to direct fluid along the outer side wall 28 of the swirl chamber 20. In one or more embodiments the direction of fluid flowing into the swirl chamber 20 from the feeder through-holes 30 may be described as flowing around a central axis 11 while the fluid is located within the swirl chamber 20. It can be desirable for any swirl chamber 20 to be formed so that the central axis 11 extends through a center of the swirl chamber 20 and parallel to the side walls 26 and 28. The inner side wall 26 defines the perimeter of the central land or island portion 29.

Each of the feeder through-holes 30 may be characterized as defining a through-hole axis 31 that extends through the outlet opening 34 of the feeder through-hole and is the direction along which fluid flowing into the swirl chamber 20 flows. In one or more embodiments, the relationship between the central axis 11 and the through-hole axes 31 defined by feeder through-holes 30 may be described as tangential. In other words, the through-hole axes 31 may be described as being directed tangential to the central axis 11.

This arrangement may be more conveniently described with reference to FIG. 2B in which the outlet openings 34 formed by feeder through-holes 30 in outer side wall 28 of swirl chamber 20 are depicted as dotted lines, with the through-hole axis 31 for each of the feeder through-holes 30 leading to each of the outlet openings 34 being depicted. As illustrated in FIG. 2B, the through-hole axes 31 do not intersect with central axis 11 and may, rather, be characterized as oriented tangential to the central axis 11 defined by swirl chamber 20.

While the view depicted in FIG. 2B is taken along central axis 11, FIG. 2C depicts a view taken orthogonal to the central axis 11 to illustrate that, in one or more embodiments, the through-hole axes 31 may be arranged or oriented to direct fluid into the swirl chamber 20 in what can be described as an inclined direction that includes an axial component, i.e., a component that is aligned with the central axis 11, such that the fluid, in addition to being directed tangential to the central axis 11, is also directed towards outlet face 14 of the nozzle structure (e.g., plate 10) and the opening 24 of swirl chamber 20. As seen in FIG. 2C, a projection of through-hole axis 31 onto central axis 11 forms an included angle α (alpha) that is less than 90°. As a result, fluid flowing into the swirl chamber 20 along an inclined through-hole axis 31 is directed both tangentially about central axis 11 and axially towards the outlet face 14 to promote exit of the fluid from the outlet opening 24 swirl chamber 20.

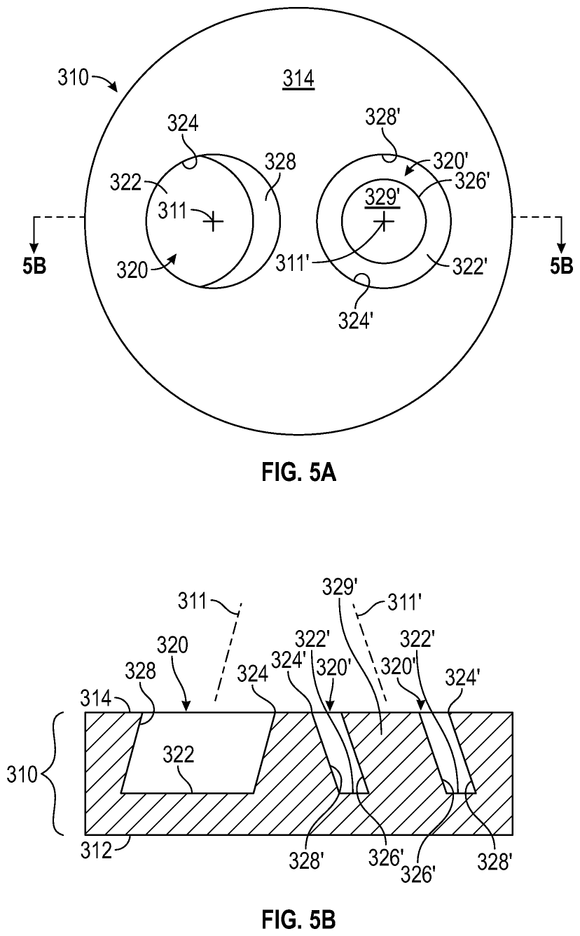

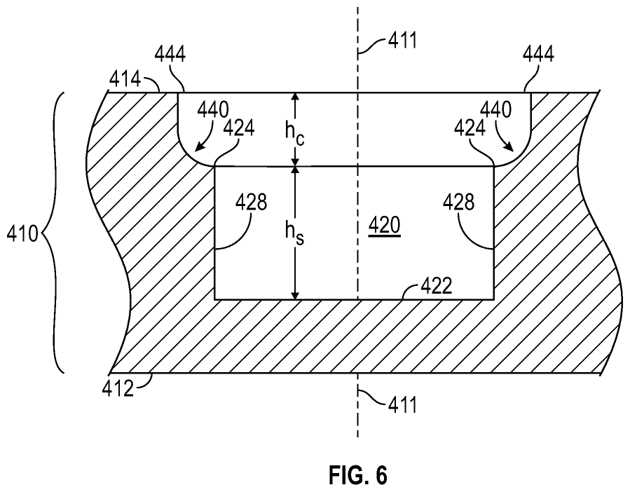

FIG. 3A is a schematic diagram depicting one illustrative embodiment of a feeder through-hole 130 defining a through-hole axis 131 that is directed at both an inner side wall 126 and an outer side wall 128 of one illustrative embodiment of a swirl chamber 120 having a central axis 111. The swirl chamber 120 opens onto outlet face 114 of nozzle structure 110 in the depicted illustrative embodiment. Fluid entering the swirl chamber 120 is incident upon both the inner side wall 126 and the outer side wall 128 before passing around the central axis 111 within the swirl chamber 120. It can be desirable for any swirl chamber 120 to be formed so that the central axis 111 extends through a center of the swirl chamber 120 and parallel to the side walls 126 and 128. The inner side wall 126 defines the perimeter of a central land or island portion 129.

FIG. 3B is a schematic diagram depicting another illustrative embodiment of a feeder through-hole 130′ defining a through-hole axis 131′ that is directed at only an outer side wall 128′ of a swirl chamber 120′ having a central axis 111′. The swirl chamber 120′ opens onto outlet face 114′ of nozzle structure 110′ in the depicted illustrative embodiment. Fluid entering the swirl chamber 120′ is incident upon the outer side wall 128′ before passing around the central axis 111′ within the swirl chamber 120′.

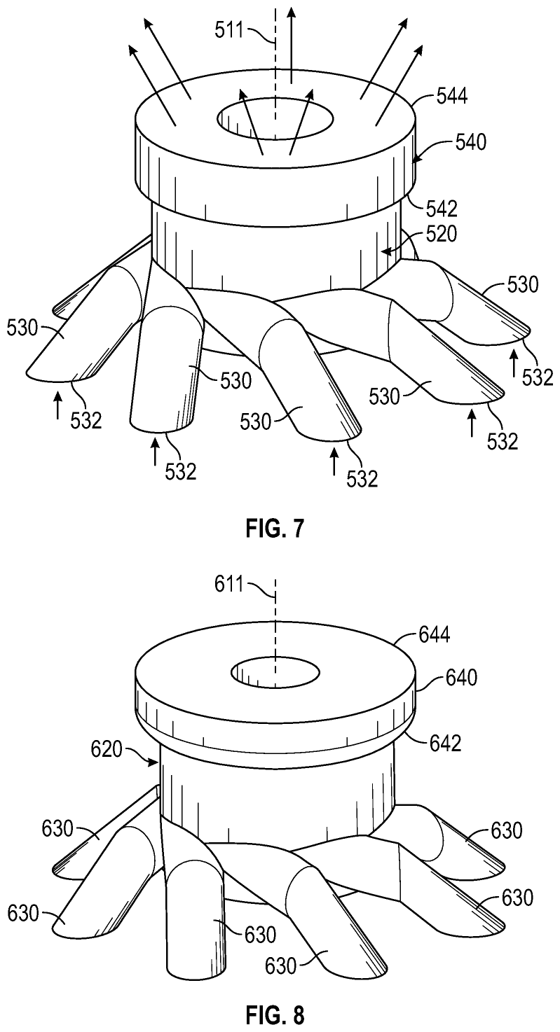

FIGS. 4A-4D are plan views of an outlet face of a nozzle structure 214 including additional illustrative embodiments of swirl chambers that may be provided in nozzle structures as described herein. For example, FIG. 4A depicts a swirl chamber 220 having an outer side wall 228, an inner side wall 226 and a bottom surface 222 in the form of a circular ring-shaped groove positioned about a central axis 211. It can be desirable for any swirl chamber 220 to be formed so that the central axis 211 extends through a center of the swirl chamber 220 and parallel to the side walls 226 and 228. The inner side wall 226 defines the perimeter of a central land or island portion 229. Swirl chambers in nozzle structures as described herein need not, however, necessarily be circular in shape. For example, FIG. 4B depicts a swirl chamber 220′ having an outer side wall 228′, an inner side wall 226′, and a bottom surface 222′ in the form of a hexagonal ring-shaped groove positioned about a central axis 211′. The inner side wall 226′ defines the perimeter of a central land or island portion 229′.

Another variation in swirl chambers provided in nozzle structures as described herein is depicted in FIG. 4C, where swirl chamber 220″ is depicted and includes an outer side wall 228″, an inner side wall 226″ and a bottom surface 222″ positioned about a central axis 211″. The inner side wall 226″ defines the perimeter of a central land or island portion 229″. In contrast, however, to the continuous circular ring-shaped groove of swirl chamber 220 in FIG. 4A, swirl chamber 220″ includes barriers 223″ that separate the swirl chamber 220″ into four separate arcuate grooves or sub-chambers. It is understood that the sub-chambers of any swirl chamber could be linear (straight) (e.g., see FIG. 4D or have any other shape, rather than arcuate (as shown in FIG. 4C).

Still another variation in swirl chambers provided in nozzle structures as described herein is shown in FIG. 4D, where swirl chamber 220′″ is depicted as either a discontinuous groove with multiple sub-chambers or a continuous groove (shown with phantom lines connecting the sub-chambers). The continuous groove swirl chamber 220′″ or each of the sub-chambers includes an outer side wall 228″, an inner side wall 226′″ and a bottom surface 222′″ positioned a spaced distance about a central axis 211′″. The inner side wall 226′″ defines the perimeter of a central land or island portion 229′″. When it is a discontinuous groove, swirl chamber 220′″ includes multiple barriers 223′″ that separate the swirl chamber 220′″ into multiple sub-chambers. When multiple sub-chambers are used, for any swirl chamber embodiment, at least one feeder through-hole directs fluid into each of the sub-chambers. In this embodiment, each sub-chamber is a linear groove.

In an alternative embodiment of swirl chamber 220′″, the illustrated phantom lines could depict the barriers 223′″ as being proximate the outlet surface 214′″ of the nozzle structure, but with each of the sub-chambers of the swirl chamber 220′″ being open and in fluid communication with each other proximate the bottom surface 222′″ (i.e., the bottom surface 222′″ and a lower portion of the side walls 226′″ and 228′″ of swirl chamber 220′″ are continuous). As a result, fluid introduced into such a swirl chamber 220′″ can circulate about central axis 211′″ proximate the bottom surface 222′″, but that circulation is interrupted by the barriers 223′″ as the fluid moves towards the outlet surface 214′″.

FIG. 5A is provided to illustrate yet another variation in nozzle structures as described herein. In particular, a nozzle structure (e.g., plate 310) can include an outlet face 314 containing two different swirl chambers 320 and 320′″ opening onto outlet face 314 of a single nozzle structure (e.g., plate 310). It will be understood that in alternative embodiments, any number of swirl chambers may be provided on a single nozzle structure in one or more embodiments of nozzle structures as described herein and, further, that if multiple swirl chambers are provided on the same nozzle structure, they may be the same or different. FIG. 5B is a cross-sectional view of nozzle plate 310 taken along line 5B-5B in FIG. 5A. Nozzle plate 310 includes an inlet face 312 and an outlet face 314. Swirl chamber 320 includes a bottom surface 322 and an outer side wall 328 that extends from the perimeter of the bottom surface 322 to an outlet opening 324 on the outlet face 314 of the nozzle plate 310. Illustrative embodiment of swirl chamber 320 defines a central axis 311 that extends through a center of the swirl chamber 320 and parallel to the side wall 328. Central axis 11 of swirl chamber 20 depicted in FIGS. 1A, 1B and 1C is normal to the outlet face 14 of nozzle plate 10. As a result, a plume of fluid exiting the outlet opening 24 of circular swirl chamber 20 would be normal to the outlet face 14 of the nozzle plate 10. In contrast, central axis 311 of swirl chamber 320 is canted at an angle that is not normal to the outlet face 314 of nozzle plate 310. As a result, any plume of fluid exiting the outlet opening 324 of circular swirl chamber 320 would also be canted at an angle that is not normal to the outlet face 314 of nozzle plate 310.

Similarly, illustrative embodiment of swirl chamber 320′ located in nozzle plate 310 also includes a bottom surface 322′ and an outer side wall 328′ that extends from the perimeter of the bottom surface 322′ to an outlet opening 324′ on the outlet face 314 of the nozzle plate 310. Swirl chamber 320′ also includes an inner side wall 326′ that also extends from the bottom surface 322′ to outlet opening 324′ on the outlet face 314 of the nozzle plate 310. The inner side wall 326′ defines the perimeter of a central land or island portion 329′.

The resulting swirl chamber 320′ is in the form of an annular ring-shaped groove or channel having a central axis 311′ that extends through a center of the swirl chamber 320′ and parallel to the side walls 326′ and 328′. Because central axis 311′ of swirl chamber 320′ is canted at an angle that is not normal to the outlet face 314 of nozzle plate 310, any plume of fluid exiting the outlet opening 324′ of circular swirl chamber 320′ would also be canted at an angle that is not normal to the outlet face 314 of nozzle plate 310.

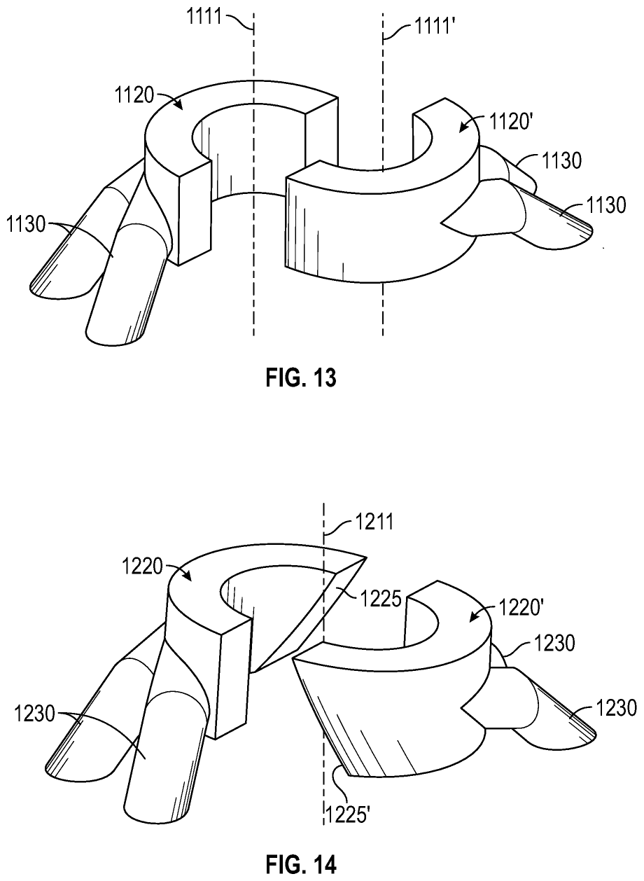

The nozzle plate 310 depicted in FIGS. 5A-5B is one illustrative embodiment of a nozzle plate 310 having an outlet face 314 defining a normal axis (i.e., an axis perpendicular to the outlet face 314) that is not parallel to the central axis of a swirl chamber provided in the nozzle structure. Another illustrative embodiment of a swirl chamber that may be used in a nozzle structure as described herein is depicted in the cross-sectional view of FIG. 6. The depicted nozzle plate 410 includes an inlet face 412 and an outlet face 414. A swirl chamber 420 is formed in nozzle plate 410 around a central axis 411 and includes an outer sidewall 428 and a bottom surface 422. The outer sidewall 428 extends from the bottom surface 422 towards the outlet face 414. It can be desirable for swirl chamber 420 to be formed so that the central axis 411 extends through a center of the swirl chamber 420 and parallel to the side wall 428. In one or more embodiments, a swirl chamber such as swirl chamber 420 may be characterized as a “blind-hole” because it is defined only by the bottom surface 422 and outer side wall 428, with no inner side wall to form a groove or channel as seen in other illustrative embodiments of swirl chambers as described herein.

The depicted swirl chamber 420 can include a counterbore 440 formed in the outlet face 414 of a nozzle structure (e.g., nozzle plate 410) such that sidewall 428 of swirl chamber 420 terminates below the outlet face 414. As a result, swirl chamber 420 can be described as having an outlet opening 424 that is inset from the outlet face 414 of nozzle plate 410, with the outlet opening 424 coinciding with a bottom edge of the counterbore 440. Counterbore 440 may further be described as having an outer edge 444, at the outlet face 414, that extends out (e.g., radially) from the central axis 411 wider than the outlet opening 424.

The addition of a counterbore to a swirl chamber of a nozzle structure as described herein may, in one or more embodiments, provide additional control over the height of the swirl chamber within a nozzle structure. In particular, the bottom edge of the counterbore, which as described above is coincident with the outlet opening of the swirl chamber, may be located at any desired intermediate position between the inlet face and the outlet face of the nozzle structure in which the swirl chamber is located. The height of the swirl chamber (i.e., the distance between the bottom surface of the swirl chamber and the bottom edge of the counterbore) can be controlled using one or more of the net-shape additive manufacturing processes, such as those described herein (e.g., using microsrucures made by single photon or multiphoton processes). In contrast, the nozzle structures described herein are often constructed using electroplating or other additive manufacturing techniques which may require post-forming grinding, electric discharge machining (EDM), or other material removal processing that result in some variations in the thickness of the nozzle structure between its inlet face and outlet face. Those post forming grinding or other material removal processes, however, do not affect the location of the bottom edge of the counterbore or the outlet opening of the swirl chamber, because those features are inset from the outlet face of the nozzle structure. In this way, the use of a counterbore can allow the height of the swirl chamber and the length of the feeder through-holes to be chosen, as desired, without concern for the distance between the inlet face and outlet face of the nozzle structure being greater than the distance between the bottom of the swirl chamber and the inlet face of the nozzle structure.

In one or more embodiments, counterbores provided in connection with swirl chambers of nozzle structures as described herein may be sized such that fluid exiting the outlet opening of a swirl chamber does not contact any, most or a significant portion of the bottom and side wall surfaces of the counterbore. The surfaces of the counterbore are considered to be significantly contacted by the fluid exiting the through-hole outlet opening, when the physical characteristics of the exiting fluid stream are significantly affected (e.g., when the desired shape and breakup of the fluid stream is not attained) or when enough fluid remains on the surfaces of the counterbore, after an injection cycle, to result in a coking build-up on the counterbore surfaces that adversely impacts the performance of the combustion event (e.g., causes excess amounts or sizes of carbon-based particles being exhausted from the combustion chamber, results in the coking build-up being directly impacted by the fuel spray exiting the through-hole, or results in the coking build-up indirectly affecting the shape of the fuel spray exiting the through-hole, etc. or any combination thereof). As a result, the counterbore can, in one or more embodiments, be characterized as allowing the height of the swirl chamber to be reduced without having to reduce the thickness of the nozzle structure or move the bottom surface of the swirl chamber closer to the outlet face of the nozzle structure. Moving the bottom surface of the swirl chamber up toward the outlet face could also require the length of the feeder through-holes to be increased. Accomplishing such a reduction in the swirl chamber height without requiring thinning of the nozzle structure as a whole may, in one or more embodiments, help maintain structural integrity of the nozzle structure as compared to a nozzle structure having a thinner overall thickness, when no counterbore is present.

In addition, it can be desirable for the swirl chamber to have a relatively shallow depth (i.e., short height) in order to reduce the distance a fluid needs to travel, before exiting the swirl chamber (i.e., to reduce the amount of time a fluid remains in the swirl chamber). Reducing the distance the fluid must travel within the swirl chamber can minimize the amount of kinetic energy lost by the fluid between exiting the feeder through-holes and leaving the swirl chamber. Maximizing or optimizing the kinetic energy retained by the fluid can help ensure that the fluid exiting the feeder through-hole will have enough kinetic energy to travel the desired distance out of the swirl chamber. It can be particularly important, when the nozzle is a fuel injector nozzle, to ensure that after the fuel injector supply valve has closed, the trailing amount of fuel remaining in the nozzle structure on the other side of the closed valve (e.g., in the feeder through-holes and swirl chamber of the nozzle plate) has enough kinetic energy to exit the swirl chamber and separate from the nozzle in time to burn in the combustion chamber (i.e., to participate in the combustion event). Any remaining fuel that does not so separate from (i.e., is still in contact with) the nozzle will likely contribute to the formation of coking deposits and, potentially, build up to the point of impeding the flow of fuel through the feeder through-holes, the swirl chamber or both. Thus, helping such trailing amounts of remaining fuel to maintain enough kinetic energy to so separate from the nozzle, also helps to avoid coking problems. The height of the counterbore (see, e.g., he in FIG. 6) along a central axis defined by a swirl chamber in a nozzle structure as described herein may preferably be limited relative to the height of the swirl chamber where the height of the swirl chamber is measured from its bottom surface to its outlet opening (see, e.g., hs in FIG. 6). For example, in one or more embodiments, it may be desirable for the height he of the counterbore along a central axis of a swirl chamber to be less than or equal to the height hs of the swirl chamber as measured from its bottom surface to its outlet opening at the bottom of the counterbore. In one or more alternative embodiments, the height he of the counterbore along a central axis of a swirl chamber may be less than or equal to one half the height hs of the swirl chamber. In still other alternative embodiments, the height he of the counterbore along a central axis of a swirl chamber may be greater than up to about two or three times the height hs of the swirl chamber. It may also be desirable for the height of the swirl chamber to be in the range of from greater than the major dimension or width of the feeder through-hole outlet opening up to and including about two, three or four times the major dimension of the feeder through-hole outlet opening.

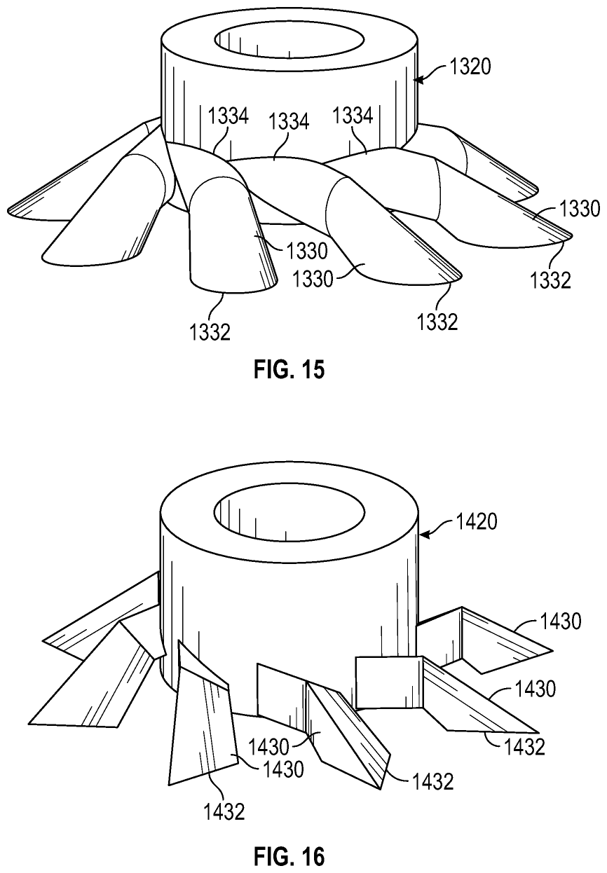

FIG. 7 is a perspective view of a negative image of another illustrative embodiment of a swirl chamber 520 having a central axis 511 and including a counterbore 540 along with feeder through-holes 530 that may be formed in a nozzle structure as described herein. Each of the feeder through-holes 530 includes an inlet opening 532 that would open on the inlet face of a nozzle structure containing the swirl chamber 520 and an outlet opening 534 that opens into the swirl chamber 520. As a result, each of the feeder through-holes 530 is used to direct a fluid flowing through the feeder through-hole 530 to swirl or otherwise flow around the swirl chamber 520. In particular, the feeder through-holes 530 may be arranged to direct fluid along the outer side wall forming the swirl chamber 520 as described herein in connection with other illustrative embodiments.

In a variation of the counterbore 440 seen in FIG. 6, counterbore 540 depicted in FIG. 7 includes a relatively sharp lower peripheral edge 542 with a straight side wall extending upward to outer edge 544 of counterbore 540 (as compared to the rounded shape of the counterbore 440 depicted in connection with swirl chamber 420). To help the trailing amounts of remaining fuel maintain enough kinetic energy to separate from the nozzle structure, it has been found desirable to eliminate such a sharp lower peripheral edge 542 of the counterbore 540 and provide a gradual (e.g., radiused) transition, rather than a sharp (e.g., right angle) transition, between the bottom surface and the outer side wall of the counterbore (see, e.g., counterbore 440 in FIG. 6). In one embodiment, this gradual transition is defined by a radius that is large enough to prevent or significantly reduce the formation of a low pressure volume (i.e., low fluid velocity volume) in the counterbore where fuel can slow down and become stagnant and trapped. It can be desirable for this gradual transition to have a radius in the range of from about 50 μm up to and including about 200 μm or more. This radius may be chosen so as to be tangential with the uppermost edge of the counterbore outer wall and the innermost edge (i.e., adjacent to the through-hole outlet opening) of the counterbore bottom surface (see, e.g., FIG. 6).

FIG. 8 is a perspective view of a negative image of another illustrative embodiment of a swirl chamber 620 having a central axis 611 and including a counterbore 640 along with feeder through-holes 630 that may be formed in a nozzle structure as described herein. Each of the feeder through-holes 630 includes an inlet opening 632 that would open on the inlet face of a nozzle structure containing the swirl chamber 620 and an outlet opening 634 that opens into the swirl chamber 620. As a result, each of the feeder through-holes 630 is used to direct a fluid flowing through the feeder through-hole 630 to swirl or otherwise flow around the swirl chamber 620. In particular, the feeder through-holes 630 may be arranged to direct fluid along the outer side wall forming the swirl chamber 620 as described herein in connection with other illustrative embodiments. In a variation of the counterbore 540 seen in FIG. 7, counterbore 640 depicted in FIG. 8 includes a rounded lower edge 642 similar to the counterbore 440 depicted in FIG. 6.

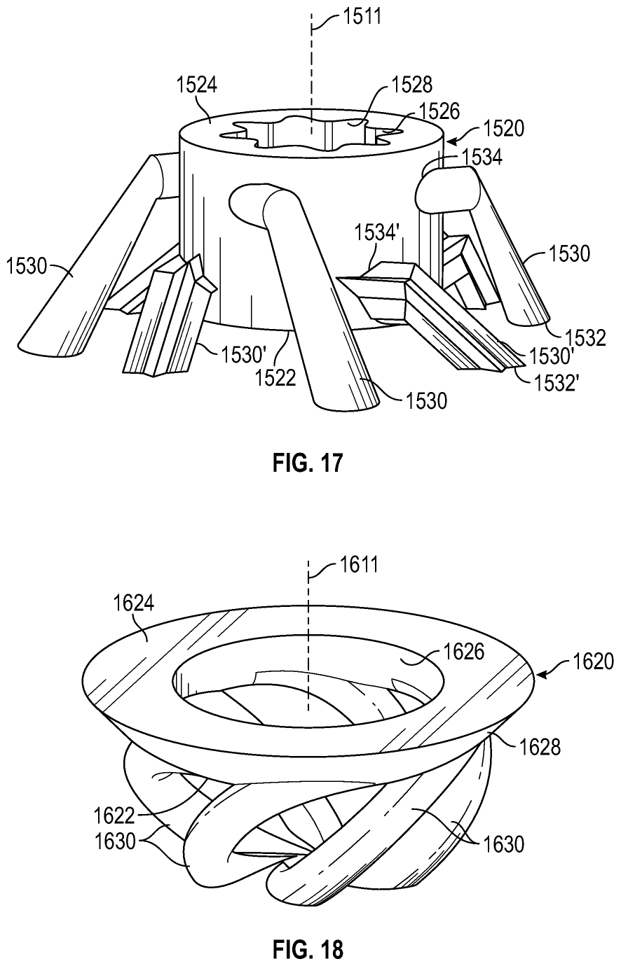

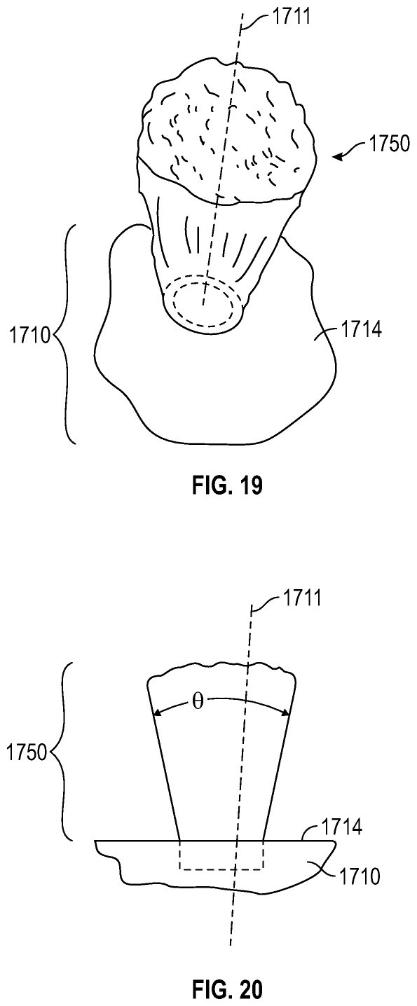

FIG. 9 is a perspective view of a negative image of another illustrative embodiment of a swirl chamber 720 having a central axis 711 and including an expansion chamber 740, in place of a counterbore, along with feeder through-holes 730 that may be formed in a nozzle structure as described herein. Each of the feeder through-holes 730 is used to direct a fluid flowing through the feeder through-hole 730 to swirl or otherwise flow around the swirl chamber 720. In particular, the feeder through-holes 730 may be arranged to direct fluid along the outer side wall forming the swirl chamber 720 as described herein in connection with other illustrative embodiments. In a variation of the embodiments described above, the expansion chamber 740 depicted in FIG. 9 is in the form of an angled outer surface that extends axially upward along axis 711 and radially outward away from axis 711 to upper edge 744 of the expansion chamber 740. Unlike with a counterbore, fluid flowing from the swirl chamber 720 is intended to contact and be guided by the outer wall of the expansion chamber 740. In this way, the angle θ formed by the spray plume or pattern exiting the swirl chamber 720 (see, e.g., FIGS. 19 and 20) can be controlled, at least in part, by changing the incline of the expansion chamber outer surface.

FIG. 10 is a perspective view of a negative image of another illustrative embodiment of a swirl chamber 820 having a central axis 811 and including a counterbore 840 along with feeder through-holes 830 that may be formed in a nozzle structure as described herein. Each of the feeder through-holes 830 is used to direct a fluid flowing through the feeder through-hole 830 to swirl or otherwise flow around the swirl chamber 820. In particular, the feeder through-holes 830 may be arranged to direct fluid along the outer side wall forming the swirl chamber 820 as described herein in connection with other illustrative embodiments. In a variation of the counterbores described above, counterbore 840 depicted in FIG. 10 includes an angled outer wall or surface that extends axially upward along axis 811 from a lower edge 842 and radially outward away from axis 811 to upper edge 844 of the counterbore 840, similar to the expansion chamber 740. One difference between counterbore 840 and expansion chamber 740 is that the lower edge 842 of counterbore 840 is spaced outwardly from the upper edge of the swirl chamber 820, while the lower edge 742 of expansion chamber 740 is coincident with the upper edge of the swirl chamber 720 as seen in FIG. 9. Having the lower edge 842 spaced outwardly in this manner can limit or eliminate the fluid spray plume or pattern from making contact with the outer wall of the counterbore 840. It may be desirable for the lower edge 842 to be radiused, as described above.

FIG. 11 is a perspective view of a negative image of another illustrative embodiment of a swirl chamber 920 having a central axis 911 and including a counterbore 940 along with feeder through-holes 930 that may be formed in a nozzle structure as described herein. Each of the feeder through-holes 930 is used to direct a fluid flowing through the feeder through-hole 930 to swirl or otherwise flow around the swirl chamber 920. In particular, the feeder through-holes 930 may be arranged to direct fluid along the outer side wall forming the swirl chamber 920 as described herein in connection with other illustrative embodiments. In a variation of the counterbores described above, counterbore 940 depicted in FIG. 12 includes an upper edge 944 that angles inwardly such that the openings formed by counterbore 940 narrows when moving upward along central axis 911. Such a narrowing of the counterbore outlet can affect the outer surface of the exiting fluid spray plume or pattern by affecting the air located between the spray plume or pattern and the outer wall of the counterbore 940. For example, such a narrowing may cause an increase in the air pressure within this space and result in the plume angle θ to drop, without the spray plume or pattern actually contacting the outer wall of the counterbore 940.

FIG. 12 is a perspective view of a negative image of another illustrative embodiment of a pair of swirl chambers arranged about a common central axis 1011. Each of swirl chambers 1020 and 1020′ is in fluid communication with feeder through-holes 1030 that may be formed in a nozzle structure as described herein. Each of the feeder through-holes 1030 is used to direct a fluid flowing through the feeder through-hole 1030 to swirl or otherwise flow around the swirl chambers 1020 and 1020′. In particular, the feeder through-holes 1030 may be arranged to direct fluid along the outer side walls forming the swirl chambers 1020 and 1020′ as described herein in connection with other illustrative embodiments.

FIG. 13 is a perspective view of a negative image of another illustrative embodiment of a pair of swirl chambers arranged about a pair of central axes 1111 and 1111′. Each of swirl chambers 1120 and 1120′ is in fluid communication with feeder through-holes 1130 that may be formed in a nozzle structure as described herein. Each of the feeder through-holes 1130 is used to direct a fluid flowing through the feeder through-hole 1130 to swirl or otherwise flow around the swirl chambers 1120 and 1120′. In particular, the feeder through-holes 1130 may be arranged to direct fluid along the outer side walls forming the swirl chambers 1120 and 1120′ as described herein in connection with other illustrative embodiments. One difference between swirl chambers 1120 and 1120′ as depicted in FIG. 13 from swirl chambers 1020 and 1020′ as depicted in FIG. 12 is that swirl chambers 1120 and 1120′are arranged about a pair of central axes 1111 and 1111′that are offset each other, while swirl chambers 1020 and 1020′ in FIG. 12 are arranged around a common central axis 1011.

FIG. 14 is a perspective view of a negative image of another illustrative embodiment of a pair of swirl chambers arranged about a common central axis 1211. Each of swirl chambers 1220 and 1220′ is in fluid communication with feeder through-holes 1230 that may be formed in a nozzle structure as described herein. Each of the feeder through-holes 1230 is used to direct a fluid flowing through the feeder through-hole 1230 to swirl or otherwise flow around the swirl chambers 1220 and 1220′. In particular, the feeder through-holes 1230 may be arranged to direct fluid along the outer side walls forming the swirl chambers 1220 and 1220′ as described herein in connection with other illustrative embodiments. One difference between swirl chambers 1220 and 1220′from swirl chambers 1020 and 1020′ is that swirl chamber 1220 includes an angled end surface 1225 while swirl chamber 1220′includes an angled end the surface 1225′. The angled end surfaces 1225 and 1225′may promote the flow of fluid out of the swirl chambers 1220 and 1220′as compared to the shape of the ends of swirl chambers 1020 and 1020′ depicted in FIG. 12.

While variations and alternatives in the shape and/or configuration of swirl chambers as described above have focused on the swirl chambers, FIGS.15-18 depict variations that may be found in the feeder through-holes used to supply fluid to the swirl chambers in nozzle structures as described herein.

FIG. 15 is a perspective view of a negative image of another illustrative embodiment of a swirl chamber 1320 and feeder through-holes 1330 that may be formed in a nozzle structure as described herein. Each of the feeder through-holes 1330 is used to direct a fluid flowing through the feeder through-hole 1330 to swirl or otherwise flow around the swirl chamber 1320. In particular, the feeder through-holes 1330 may be arranged to direct fluid along the outer side wall forming the swirl chamber 1320 as described herein in connection with other illustrative embodiments. The feeder through-holes 1330 include inlet openings 1332 that open on the inlet face of a nozzle structure in which the swirl chamber 1320 is located and outlet openings 1334 that open into the swirl chamber 1320 as described herein in connection with other illustrative embodiments. One difference in feeder through-holes 1330 as depicted in FIG. 15 is, however, that the cross-sectional area of the feeder through-holes 1330 changes between the inlet opening 1332 and the outlet opening 1334. In particular, the depicted illustrative embodiment of feeder through-holes 1330 in FIG. 15 includes larger inlet openings 1332 than outlet openings 1334, such that the cross-sectional area of the feeder through-holes 1330 decreases when moving from the inlet opening 1332 to the outlet opening 1334. Such a feeder through-hole configuration can cause the velocity of fluid to increase as it flows through and exits the feeder through-hole. Such an increase in velocity can helps to ensure that the fluid exiting the feeder through-hole will have enough kinetic energy to travel out of the swirl chamber. This can be particularly important, when the nozzle is a fuel injector nozzle, in order to ensure that after the fuel injector supply valve has closed, the trailing amount of the fuel has enough kinetic energy to exit the swirl chamber in time to burn in the combustion chamber (i.e., to participate in the combustion event). In other alternative embodiments, it may be possible that the reverse arrangement occurs, i.e., the cross-sectional area of the feeder through-holes may increase when moving from their respective inlet openings to their respective outlet openings.

FIG. 16 is a perspective view of a negative image of another illustrative embodiment of a swirl chamber 1420 and feeder through-holes 1430 that may be formed in a nozzle structure as described herein. Each of the feeder through-holes 1430 is used to direct a fluid flowing through the feeder through-hole 1430 to swirl or otherwise flow around the swirl chamber 1420. In particular, the feeder through-holes 1430 may be arranged to direct fluid along the outer side wall forming the swirl chamber 1420 as described herein in connection with other illustrative embodiments. The feeder through-holes 1430 include inlet openings 1432 that open on the inlet face of a nozzle structure in which the swirl chamber 1420 is located and outlet openings 1434 that open into the swirl chamber 1420 as described herein in connection with other illustrative embodiments. One difference in feeder through-holes 1430 as depicted in FIG. 16 is, however, that the cross-sectional shape of the feeder through-holes 1430 (taken in a plane transverse to the length of the through-holes) it is not circular or elliptical as seen in connection with other illustrative embodiments of feeder through-holes described herein. Rather, the feeder through-holes 1430 depicted in FIG. 16 have a generally triangular cross-sectional shape.

Feeder through-holes with still other cross-sectional shapes are also possible in other alternative embodiments. Although the number of alternative shapes for feeder through-holes used in swirl chambers as described herein is essentially infinite, other examples of alternative cross-sectional shapes for feeder through-holes that may be used to deliver fluid to swirl chambers as described herein include elliptical, oval, star-shaped, pentagonal, hexagonal, etc.

FIG. 17 is a perspective view of a negative image of another illustrative embodiment of a swirl chamber 1520 and feeder through-holes 1530 and 1530′ that may be formed in a nozzle structure as described herein. Each of the feeder through-holes 1530 and 1530′ is used to direct a fluid flowing through the feeder through-holes 1530 and 1530′ to swirl or otherwise flow around the central axis 1511 and out the swirl chamber 1520. In particular, the feeder through-holes 1530 and 1530′ may be arranged to direct fluid along the outer side wall forming the swirl chamber 1520 as described herein in connection with other illustrative embodiments. The feeder through-holes 1530 and 1530′ include inlet openings 1532 and 1532′ (respectively) that open on the inlet face of a nozzle structure in which the swirl chamber 1520 is located and outlet openings 1534 and 1534′ (respectively) that open into the swirl chamber 1520 as described herein in connection with other illustrative embodiments. Among the variations depicted in FIG. 17 are the shape of the inner side wall 1526 forming the swirl chamber 1520. As depicted, inner side wall 1526 is in the form of an undulating or corrugated surface that moves towards and away from the outer wall 1528 of the swirl chamber 1520. Another variation depicted in

FIG. 17 is in the position of the outlet openings 1534 and 1534′ of the feeder through-holes 1530 and 1530′. As depicted, the outlet openings 1534 of feeder through-holes 1530 enter the swirl chamber 1520 closer to the outlet opening 1524 of the swirl chamber 1520 than the bottom surface 1522 of the swirl chamber 1520. Conversely, the outlet openings 1534′ of feeder through-holes 1530′ enter the swirl chamber 1520 farther from the outlet opening 1524 of the swirl chamber 1520 than the bottom surface 1522 of the swirl chamber 1520. This feature of having the outlet openings of the feeder through-holes disposed at different locations along the height of the swirl chamber can be employed for any embodiment of the present invention. Many other variations in placement of the outlet openings of feeder through-holes used in connection with swirl chambers as described herein may be possible including, for example, having one or more sets of three or more such outlet openings aligned along a line forming an acute angle with the central axis 1511. Yet another variation depicted in FIG. 17 is that the same swirl chamber 1520 is fed by feeder through-holes 1530 and 1530′ that have different cross-sectional shapes. In other words, swirl chambers of nozzle structures as described herein may be fed by feeder through-holes having a variety of different shapes, different entry positions into the swirl chamber and other variations as described herein.

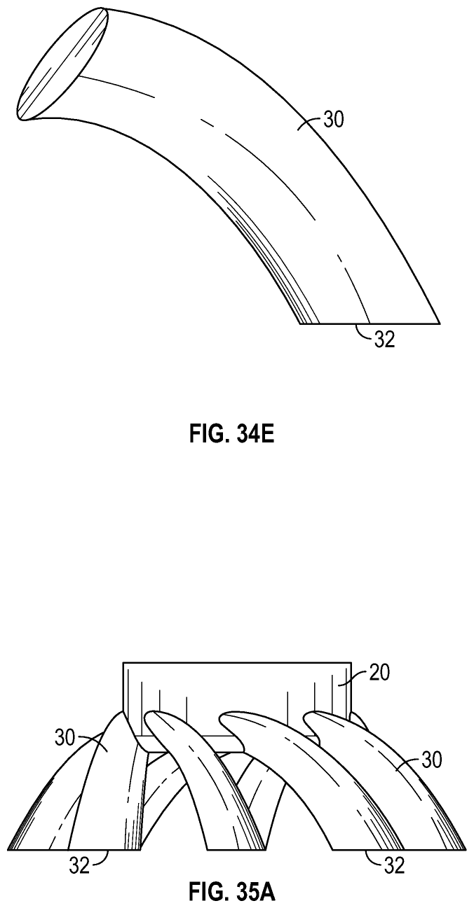

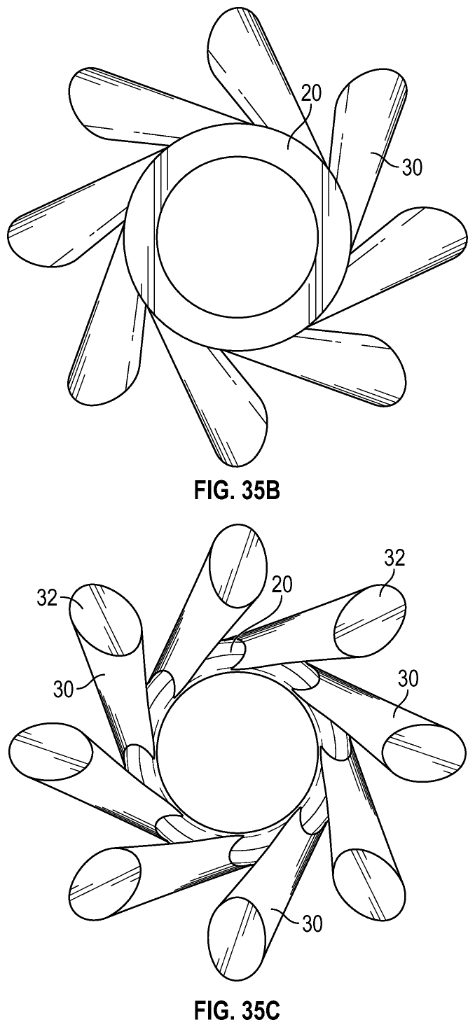

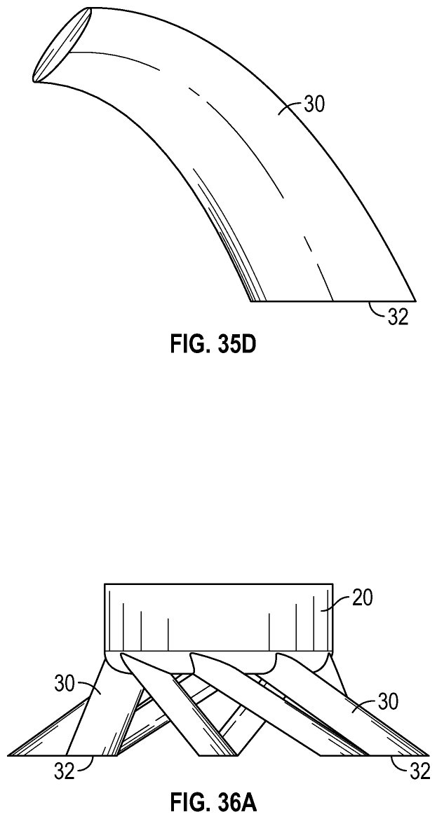

FIG. 18 is a perspective view of a negative image of another illustrative embodiment of a swirl chamber 1620 and feeder through-holes 1630 that may be formed in a nozzle structure as described herein. Each of the feeder through-holes 1630 is used to direct a fluid flowing through the feeder through-holes 1630 to swirl or otherwise flow around the swirl chamber 1620. In particular, the feeder through-holes 1630 may be arranged, with their inlet openings disposed in close proximity to each other within the outer periphery of the swirl chamber and each feeder through-hole first curving outwardly and then back inwardly, to direct fluid to enter around the swirl chamber 1620. Such a feeder through-hole configuration can make it possible, or at least easier, to have one inlet opening feeding all of the feeder through-holes. Such a feeder through-hole configuration can also allow the area of the inlet surface or face, where the through-hole inlet openings 32 are located (e.g., see reference Am in FIG. 34C), to be defined by the outer perimeter of the swirl chamber. By reducing the inlet opening area Apo, benefits can result such as, for example, reducing the strength and/or thickness of the material used to make the nozzle plate. The swirl chamber 1620 includes an inner side wall 1626 and an outer side wall 1628 that forms an angled surface extending axially upward along axis 1611 and radially outward away from axis 1611 to the upper edge of the swirl chamber 1620 so as to open onto the outlet face of a nozzle structure containing the swirl chamber 1620 and form an outlet opening 1624. Because the outer side wall 1626 is so angled, the swirl chamber 1620 functions like an expansion chamber (such as, e.g., the expansion chamber 740 of FIG. 9), with fluid flowing through the swirl chamber 1620 contacting and being guided by the outer side wall 1626 so that the angle 0 formed by the spray plume or pattern exiting the swirl chamber 1620 (see, e.g., FIGS. 19 and 20) can be controlled, at least in part, by changing the incline of the outer side wall 1626.

In one or more embodiments, the nozzle structures with swirl chambers and associated feeder through-holes as described herein may form funnel-shaped fluid plumes that may be useful in, for example, delivering fuel into the combustion chamber of an internal combustion engine. As used herein, the term “funnel-shaped fluid plume” refers to the shape of the fluid, while the fluid is in the swirl chamber and after the fluid exits the swirl chamber. While in the swirl chamber, the fluid may be described as having a tubular shape, and while outside of the swirl chamber, the fluid can be seen as having a cone shape. Together, the two shapes can be seen as generally forming a funnel shape. While inside the continuous annular groove embodiment of the swirl chamber, the tubular portion of the plume is generally hollow. While inside a swirl chamber, the tubular portion can have more of a solid tubular shape, with a fluid droplet distribution across from side to side of the tubular-shaped portion of the plume. The tubular portion of the plume may also be generally hollow. It is believed this fluid droplet distribution has a higher concentration of droplets around the outer periphery, than in the center, of the tubular-shaped portion of the plume.

The funnel-shaped plumes can be hollow or filled with fluid droplets and/or streams. When viewed in cross section, along a plane that passes through the central longitudinal axis of the funnel-shaped fluid plume, generally perpendicular to the outlet face of the nozzle structure, it can be desirable for opposite sides of the funnel-shape to form an angle θ therebetween having a width in the range of from at least about 25° up to and including about 135°. The cone-shaped portion of the plume can be generally hollow (i.e., less than 25% of the space within the wall of the cone-shaped portion contains the fluid), or the space within the wall of the cone-shaped portion can have a fluid content of at least 25% up to less than 50%, greater than or equal to 50%, or at least 75%. The tubular-shaped portion may likewise be generally hollow to the same degree as the cone-shaped portion. FIGS. 19-20 depict one illustrative funnel-shaped spray pattern or plume 1750 forming an angle θ between its opposing sides or edges that may be formed using a nozzle structure 1710 having a swirl chamber 1720 that opens onto an outlet face 1714 of nozzle structure 1710, with the depicted funnel-shaped plume 1750 being positioned around central axis 1711.

When the funnel shape is a hollow funnel-shaped wall, it can be desirable for the wall to be continuous or discontinuous. The funnel-shaped wall is considered continuous, when all or most (i.e., greater than 30%, 35%, 40%, 45%, 50%, 55%, 60%, 65%, 70%, 75%, 80%, 85%, 90%, or 95%) of any fluid droplet or stream makes contact with or is in close proximity to at least one other fluid droplet or stream. A given fluid droplet or stream is in close proximity to another droplet or stream when the gap between them is less than the diameter of the given fluid droplet or stream. The funnel-shaped wall is considered discontinuous, when all, most (i.e., greater than 50%, 55%, 60%, 65%, 70%, 75%, 80%, 85%, 90%, or 95% and up to but not including 100%) or a substantial amount (i.e., greater than 10%, 15%, 20%, 25%, 30%, 35%, 40%, or 45% and up to and including 50%) of any fluid droplet or stream is not in close proximity to another droplet or stream. When the fluid is a fuel for an internal combustion engine, the term “funnel-shaped plume” refers to the shape of the fuel, while it is in the swirl chamber, after it exits the swirl chamber and before it is combusted in the combustion chamber of the engine. A funnel-shaped plume has an initial cylinder-shaped portion at least partially, mostly or completely located within the swirl chamber, and a cone-shaped portion located outside the swirl chamber and extending from the initial cylinder-shaped portion. It can be desirable for the internal combustion engine to be, e.g., a gasoline direct injection (GDI) engine or another type of direct injection (DI) engine. The nozzle structures described herein can be a flat plate, curved plate, compound curved plate, or otherwise have a three-dimensional structure where the surface of the inlet face and the surface of the outlet face are different. It can be desirable for the outlet face of the nozzle structure to be flat, hemispherical, curved or otherwise have a three-dimensional shape. It can also be desirable for all, most (i.e., greater than 50%, 55%, 60%, 65%, 70%, 75%, 80%, 85%, 90%, or 95%) or substantially none (i.e., in the range of from 0% to less than 50%, 45%, 40%, 35%, 30%, 25%, 20%, 15%, 10%, or 5%) of the surface area of the inlet face and outlet face of the nozzle structure to be exactly (i.e., within conventional fabrication tolerances) or generally (i.e., within up to about 1 degree from) parallel to each other.

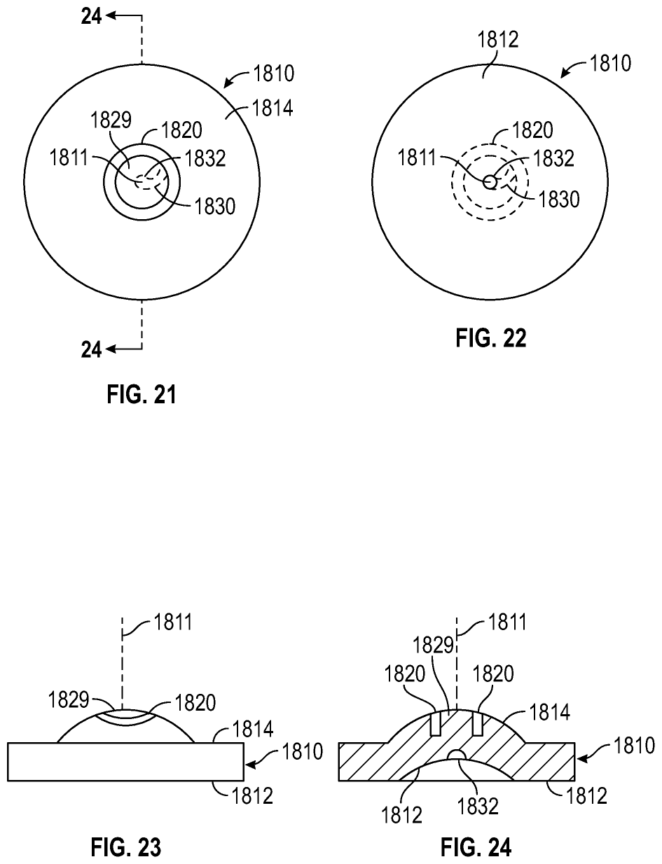

Various illustrative embodiments of nozzle plates having flat inlet and outlet faces are described and depicted above. FIGS. 21-24 depict top, bottom, side and cross-sectional views of one alternative illustrative embodiment of a nozzle plate having inlet and outlet faces that have a three-dimensional shape. In particular, nozzle plate 1810 includes an inlet face 1812 and an outlet face 1814. Nozzle plate 1810 also includes a swirl chamber 1820 defined in part by a central land or island portion 1829, a feeder through-hole 1830, and an inlet opening 1832 for the feeder through-hole 1830. The feeder through-hole 1830 leads into swirl chamber 1820 and delivers fluid into the swirl chamber along a direction having both a tangential component and an axial component relative to central axis 1811. As seen in FIG. 24, a portion of the inlet face 1812 and a portion of the outlet face 1814 have a three-dimensional curvature. Although the depicted three-dimensional curvature of the inlet face 1812 and the outlet face 1814 match, other alternative embodiments may include inlet and/or outlet faces with three-dimensional curvature that do not match each other.

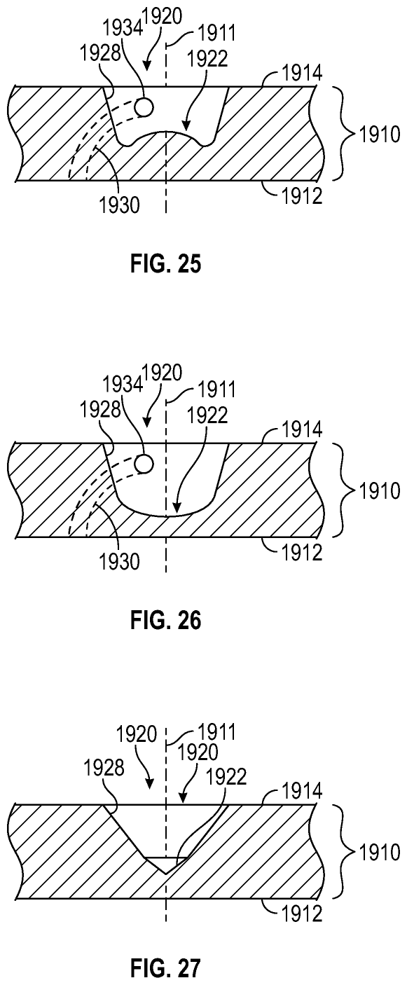

FIGS. 25-28 are cross-sectional views of alternative illustrative embodiments of swirl chambers that may be provided in a nozzle plate as described herein. In particular, FIGS. 25-28 depict illustrative embodiments of nozzle plates 1910, each of which includes an inlet face 1912 and an outlet face 1914 into which a swirl chamber 1920 is formed.

Each of swirl chambers 1920 includes a bottom surface 1922 and an outer side wall 1928 which, together, define a central axis 1911. FIGS. 25-26 also depict a feeder through-hole 1930 leading to an outlet opening 1934 in the swirl chambers 1920.

Each of the swirl chambers depicted in FIGS. 25-28 may be described as being in the form of a blind hole having a bottom surface 1922 with a center point that coincides with the intersection of axis 1911 and the bottom surface 1922, with the bottom surface 1922 having a periphery from which outer side wall 1928 extends. In one or more embodiments, the periphery of bottom surface 1922 may be fairly well defined by a change in direction of the interior surface of the swirl chamber 1920 as seen in, e.g., FIGS. 25 and 28.

In other embodiments, the periphery of bottom surface 1922 may not be fairly well defined as seen in, e.g., FIGS. 26-27. In those embodiments where the periphery of the bottom surface of a swirl chamber as described herein is not particularly well defined, the periphery of the bottom surface may be described as the location furthest from a center point of the bottom surface through which an axis extending normal to the bottom surface intersects with the outer side wall on the opposite side of the swirl chamber.

In one or more embodiments of swirl chambers found in nozzle structures as described herein, the center point of the bottom surface of the swirl chamber may be elevated such that the center point of the bottom surface is closer to the outlet face than a periphery or perimeter of the bottom surface. Examples of such an arrangement may be found in the swirl chambers 1920 depicted in FIGS. 25 and 28. In one or more alternative embodiments of swirl chambers found in nozzle structures as described herein, the center point of the bottom surface of the swirl chamber may be located further from the outlet face of the nozzle structure than a periphery or perimeter of the bottom surface. Examples of such an arrangement may be found in the swirl chambers 1920 depicted in FIGS. 26-27. In such embodiments, the bottom surfaces of the swirl chambers may be described as having a bottom surface that slopes upward towards the outlet face of the nozzle structure or downward away from the outlet face of the nozzle structure when moving from the center point of the bottom surface towards its periphery or perimeter.

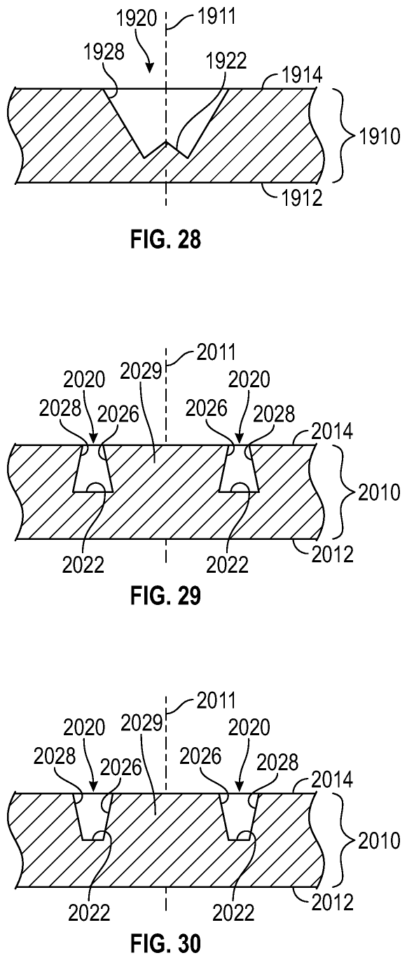

FIGS. 29-30 are cross-sectional views of other alternative illustrative embodiments of swirl chambers that may be provided in a nozzle structure as described herein that may be used to describe variations in the shape or orientation of the side walls of a swirl chamber as described herein. In both FIGS. 29-30, a nozzle plate 2010 is depicted in includes an inlet face 2012 and an outlet face 2014. Swirl chambers 2020 are found in both nozzle plates 2010 depicted in FIGS. 29-30 and include a bottom surface 2022, an inner sidewall 2026 and an outer side wall 2028. The inner side wall 2026 defines the perimeter of a central land or island portion 2029. The swirl chambers 2020 also define a central axis 2011 extending through the inlet face 2012 an outlet face 2014.

Both swirl chambers 2020 depicted in FIGS. 29-30 include side walls that define a swirl chamber having a varying width measured radially from the central axis 2011. In FIG. 29, the inner sidewall 2026 and outer side wall 2028 form a swirl chamber 2020 that narrows when moving from its bottom surface 2022 towards outlet face 2014. In FIG. 30, the inner sidewall 2026 and outer side wall 2028 form a swirl chamber 2020 that widens when moving from its bottom surface 2022 towards outlet face 2014. In one or more embodiments, each of the inner side wall 2026 and the outer side wall 2028 of each swirl chamber 2020 may form an angle with the outlet face that is in the range of from at least about 30° up to about 150°, or from at least about 45° up to about 135°. The angle formed by the side walls 2026 and 2028 may be the same or different, the side walls 2026 and 2028 may be both inclined in the same, different or opposite directions, or only one may be inclined.

Alternative illustrative embodiments of swirl chambers found in nozzle structures as described herein may include widths that vary in any selected manner, e.g., the swirl chambers may both widen and narrow or vice versa when moving from the bottom surfaces towards the outlet faces within the swirl chambers.

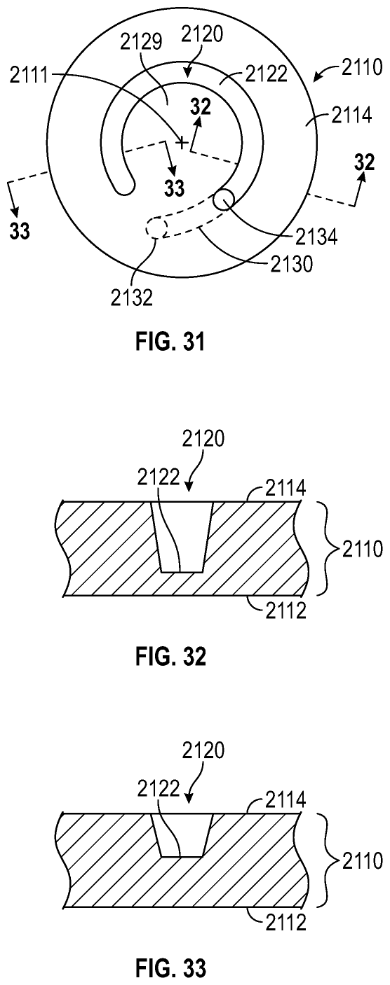

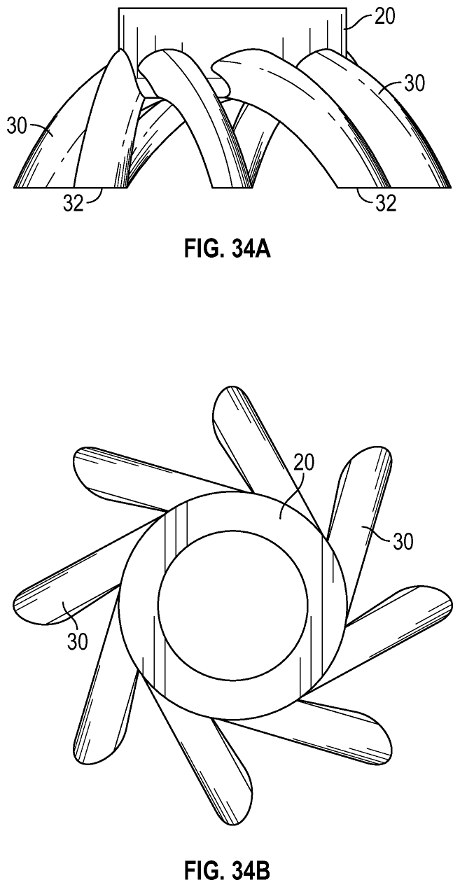

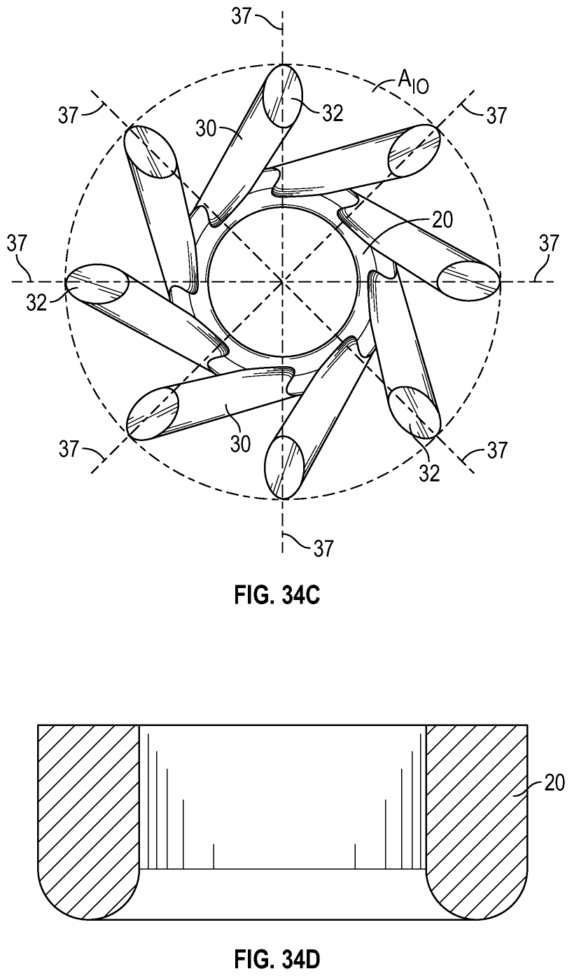

FIGS. 31-33 depict another alternative illustrative embodiment of a nozzle structure as described herein. The depicted nozzle plate 2110 includes an inlet face 2112, an outlet face 2114 and a swirl chamber 2120 formed therein and defined in part by a central land or island portion 2129. A single feeder through-hole 2130 is used to supply fluid to swirl chamber 2120 and includes an inlet opening 2132 on the inlet face 2112 of the nozzle plate 2110 and an outlet opening 2134 opening into swirl chamber 2120. The outlet opening 2134 can open at least partially into the bottom surface 2122 of the swirl chamber 2120, as shown in FIG. 31, or the outlet opening 2134 can open into the swirl chamber 2120 through a corresponding end wall of the chamber 2120 (e.g., the end wall where reference number 2134 is located). One optional feature depicted in connection with swirl chamber 2120 is that the depth of the swirl chamber changes along its length. In particular, for example, the depth of the swirl chamber 2120 can decrease when moving from the outlet opening 2134 towards the opposite end of the swirl chamber 2120 about central axis 2111. The change in depth of the swirl chamber 2120 as measured by the distance between the bottom surface 2122 and outlet face 2114 is seen in the cross-sectional views of FIGS. 32-33. In FIG. 32, which is closer to outlet opening 2134, the distance between bottom surface 2122 and outlet face 2114 is greater than the distance between bottom surface 2122 and outlet face 2114 as seen in FIG. 33. In one or more embodiments, a swirl chamber with a changing depth between the bottom surface and outlet face may be described as having an inclined bottom surface which may, in one or more embodiments, provide an axial component to guide or direct the fluid moving through the swirl chamber upward so as to promote exiting of the fluid from the swirl chamber toward the outlet face of a nozzle structure as described herein.

This invention may take on various modifications and alterations without departing from its spirit and scope. Thus, any combination of the nozzle structure features (e.g., swirl chamber, through-hole, counterbore or other nozzle structure design features) is intended to be within the scope of this invention. The following are examples of such modifications and alterations:

The nozzle designs of FIGS. 2A and 7-17 each have side entry feeder through-holes with a sharp angle bend, approximately midway between the inlet opening and the swirl chamber. The nozzle designs of FIGS. 34-41 are meant to augment those already described in the application with a few more variations that could possibly prove useful. Any combination of the features of any nozzle designs disclosed herein, including those of FIGS. 34-41, are envisioned within the scope of the present invention.

Referring to FIGS. 34A-34D, one embodiment of a negative image supply port according to the present invention has a swirl chamber 20 and multiple feeder through-holes 30, with each feeder through-hole 30 having an elliptical cross-section and being curved along its length, as opposed to the straight bent feeder through-holes with a generally circular cross-section (see, e.g., FIGS. 7-16). In one embodiment, the major axis of the feeder through-hole's elliptical shape is along the rays 37 emanating radially from the center of the nozzle structure and of the valve aperture. In another embodiment, the minor axis of each elliptical shaped feeder through-hole 30 could be designed to have this same orientation. In this embodiment (see FIG. 34D), the swirl chamber 20 has a rounded or curved, rather than a flat (i.e., rectangular cross section), bottom surface to decrease SAC volume and remove in-effective lower corners. In general, the feeder through-holes should be designed with a size and orientation that allows a sufficient amount of nozzle structure material to remain between the feeder through-hole for the structural integrity of the nozzle structure. “SAC volume” is a well known term that refers to a relatively small volume of space formed between the inlet face of a fuel injector nozzle that forms a seal with a leading surface of a fuel injector valve. Fuel can remain within this SAC volume during each combustion cycle of the corresponding combustion chamber of an internal combustion engine. Fuel remaining within the SAC volume can result in one or more detrimental effects including, but not limited to, “coking” or the pyrolysis of fuel to form carbonaceous deposits therein, distortion of fuel plume due to the inertial effect of the SAC volume as the injection event initiates and/or terminates, poorly defined droplet size (typically too large) that results from the emission of the SAC volume, and poor penetration of fuel streams. It is, therefore, desirable to eliminate or at least minimize the SAC volume.

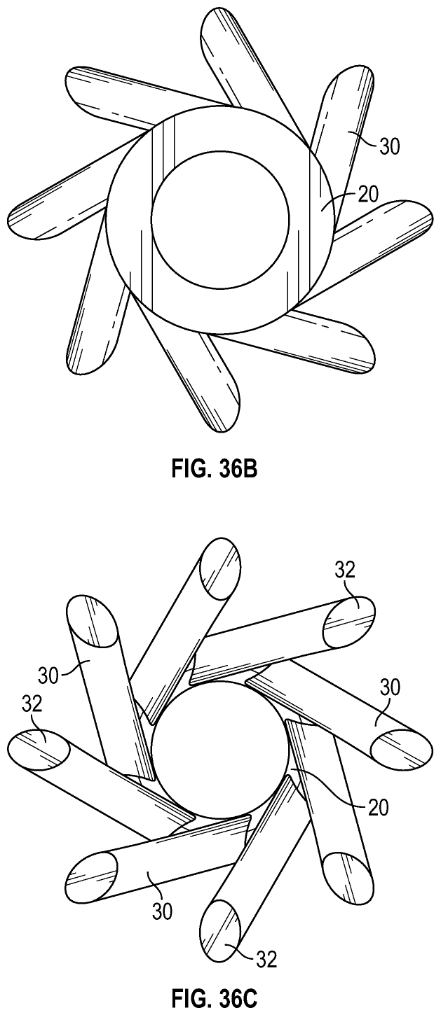

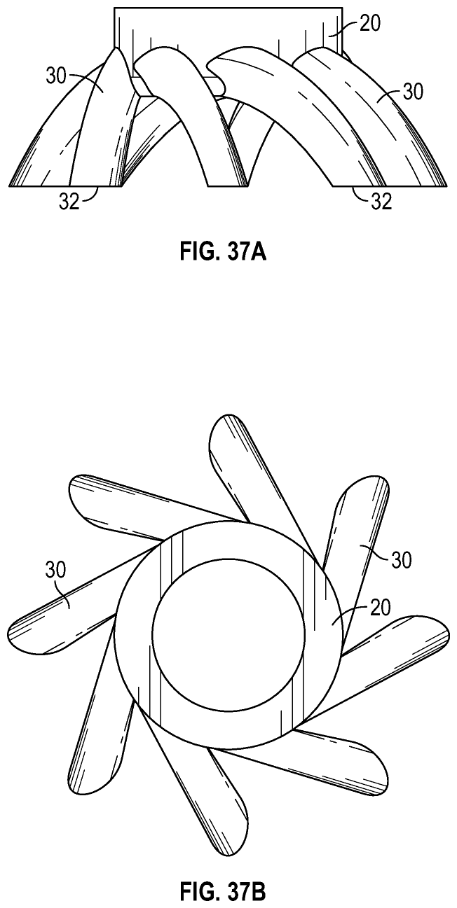

The feeder through-holes 30 shown in FIGS. 34A-34E maintain a relatively constant cross-sectional area from the inlet opening all the way to the swirl chamber 20. In contrast, the cross-sectional area of the feeder through-holes 30 shown in FIGS. 35A-35D, decreases from their inlet openings 32 to their swirl chamber 20. This area decrease can increase the speed of the fluid and thereby increase the kinetic energy of the fluid as it enters the swirl chamber 20.

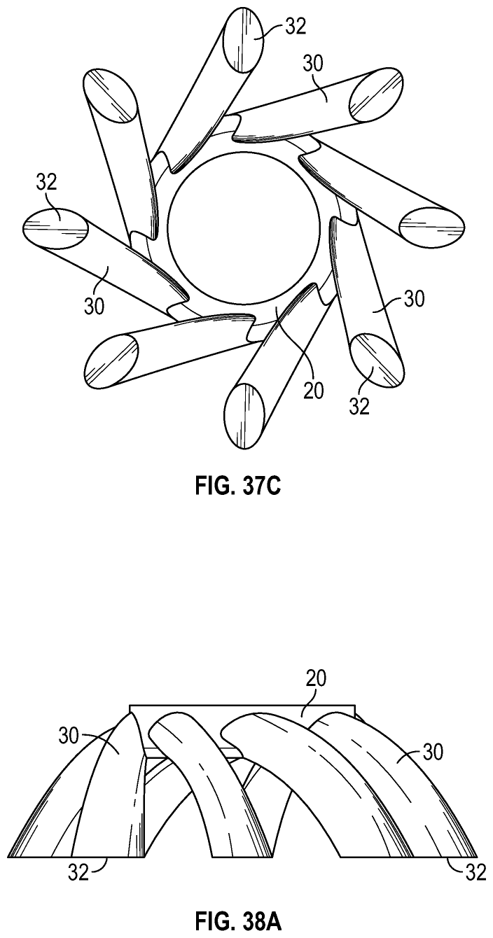

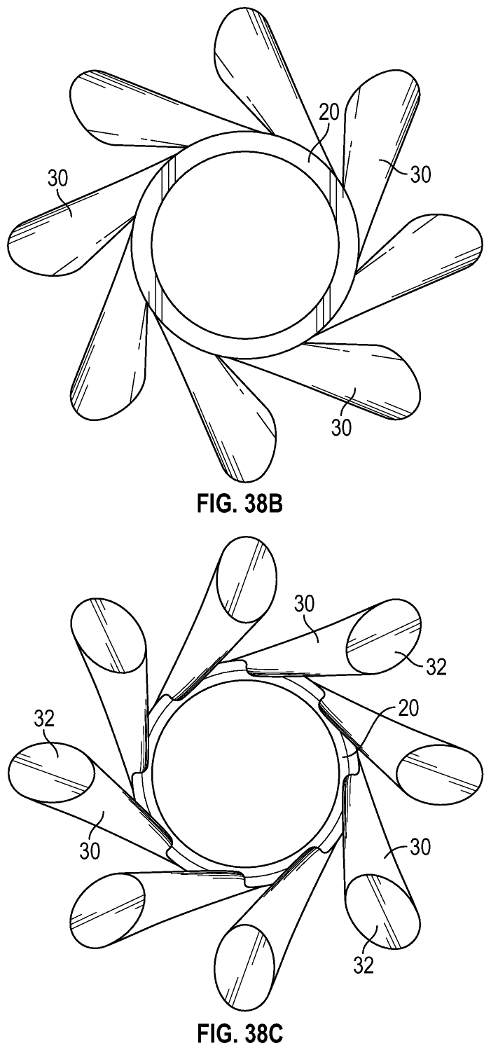

Referring to FIGS. 36A-36C, a similar supply port is shown, as in FIGS. 34A-34C, except that the feeder through-holes are straight without either a bend or a curve. When using such straight feeder through-holes 30, it may be desirable to increase the thickness of the nozzle plate 10, at least in the area of the inlet surface or face 12 where the through-hole inlet openings 32 are located (e.g., see reference Am in FIG. 34C) or increase this inlet opening area Am of the inlet surface or face 12 or both. For the same distance from their inlet to outlet openings, bent or curved feeder through-holes 30 may not require the nozzle plate 10 to be as thick and/or the inlet opening area Am being as large as that used when the feeder through-holes 30 are straight. Referring to FIGS. 37A-37C, a supply port is shown that is similar to that shown in FIGS. 34A-E, except that the feeder through-holes 30 curve toward the bottom of the swirl chamber 20 and have a twist along their path. This twist aligns the major axis of the elliptical-shaped outlet opening vertically so as to be generally aligned or parallel to the outer side wall of the swirl chamber 20, thereby minimizing the feeder through-hole's width at the intersection with the swirl chamber 20.

This narrower feeder through-hole profile allows the width of the swirl chamber 20 to also be narrower, which can allow for a lower SAC volume.

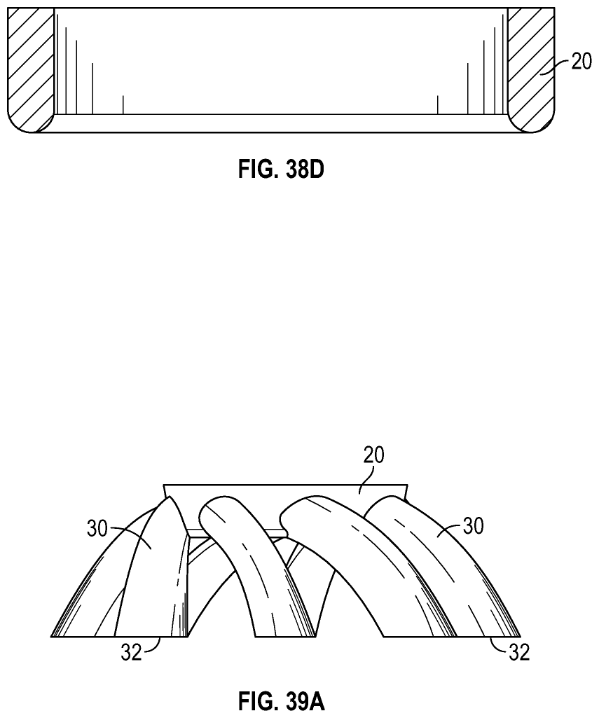

Referring to FIGS. 38A-38C, a supply port is shown that combines the rounded bottom swirl chamber 20 with the curved, tapered and twisted feeder through-holes to minimize SAC volume and to help maximize fluid velocity within the swirl chamber 20.

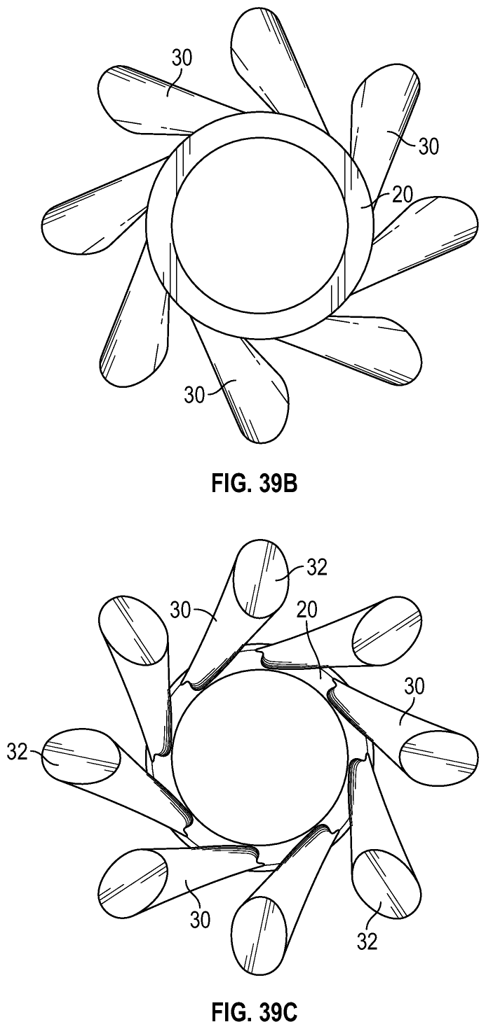

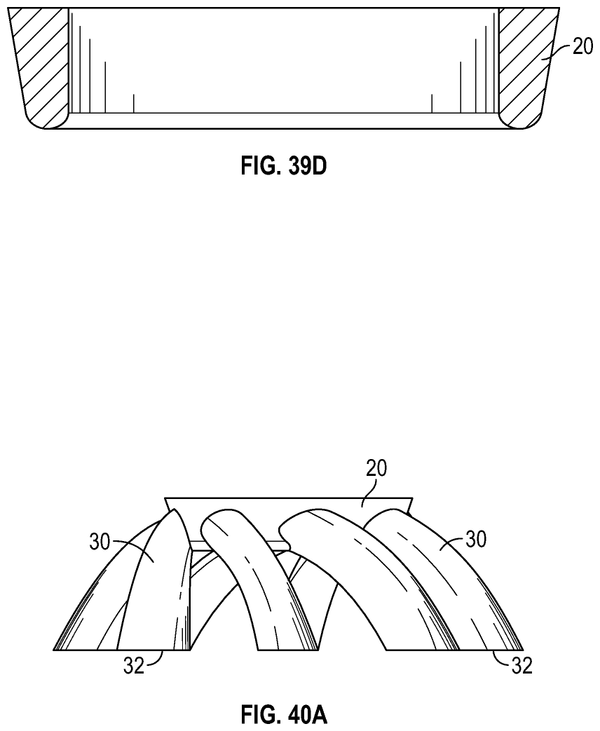

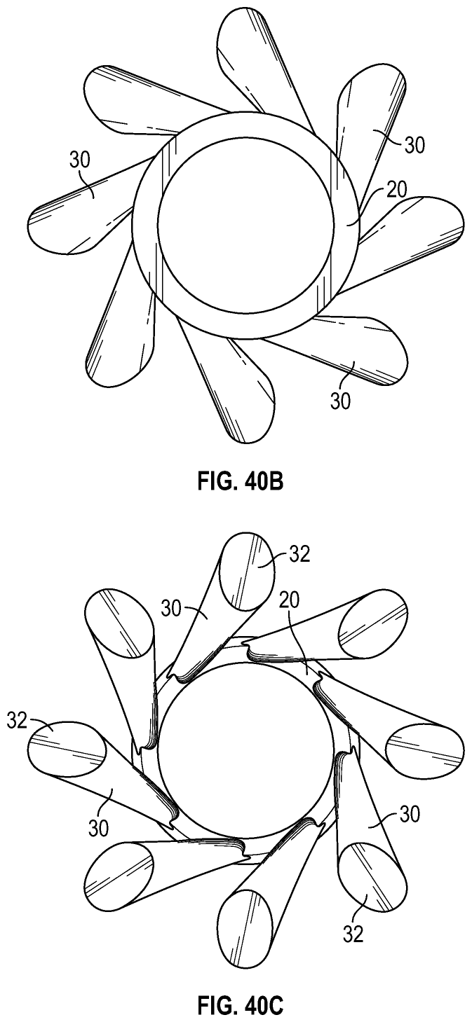

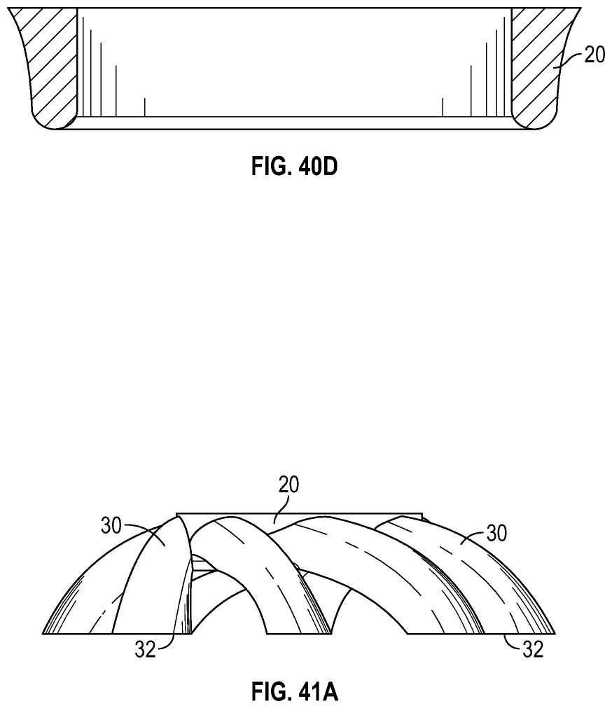

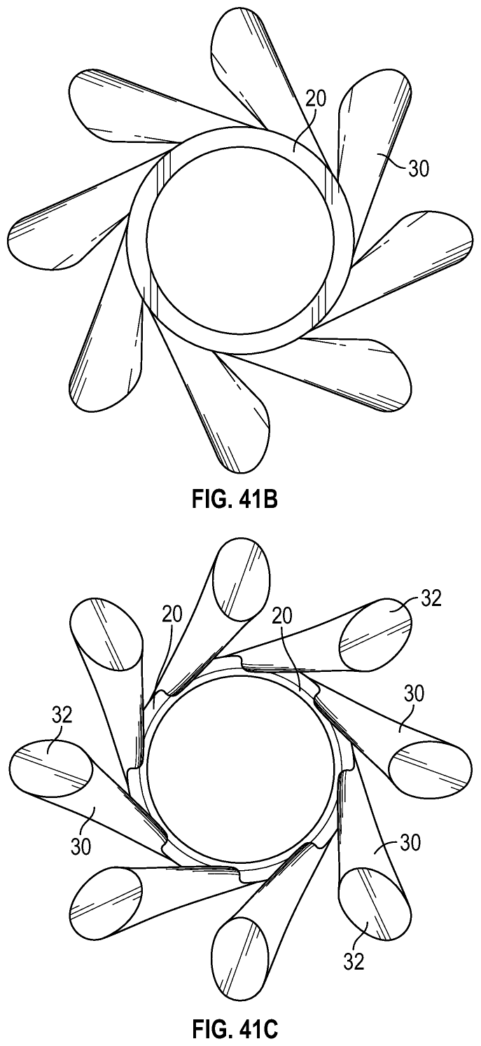

In this embodiment, the thickness of the nozzle plate 10, at least in the inlet opening area Am, was reduced to decrease the depth of the swirl chamber 20. Such a reduction in depth could also be accomplished by use of a counterbore on the swirl chamber outlet opening (see, e.g., FIGS. 6-11). Referring to FIGS. 39A-39D and FIGS. 40A-40D, two supply ports are shown that are similar to that shown in FIGS. 38A-38D, except the shape of the swirl chamber's outer side wall has been angled (see FIGS. 39A-39D) or curved (see FIGS. 40A-40D). Using a swirl chamber with an angled or curved outer side wall can cause the spray plume's cone-angle (see, e.g., FIG. 20) to widen and increase the breadth of the fluid cone's wall. It is believed that such an expanding profile of the swirl chamber 20 can minimize the effects of coking. Theoretically, a carbon deposit could become wedged in the parallel inner and outer side walls of the swirl chamber 20 of FIGS. 38A-38D, but such a carbon deposit could be more easily cleared in the ever-widening opening of these two swirl chambers (FIGS. 39A-39D and FIGS. 40A-40D). The inner side wall of the swirl chamber 20 could also have similar contour(s). Referring to FIGS. 41A-41C, another supply port design is a lower profile and lower SAC volume version of the supply port design of FIGS. 38A-38D.

### Additional Embodiments

1. A fluid (e.g., a liquid or gaseous fuel) supplying nozzle comprising a nozzle structure having an inlet face on an inlet side, an outlet face on an outlet side, a thickness between the inlet face and the outlet face, and at least one fluid supply port or through-hole comprising: a swirl chamber located within the thickness and defined at least in part by a bottom surface having a periphery and an outer side wall located along the periphery of the bottom surface and extending from the bottom surface toward the outlet side so as to form an outer periphery of at least one outlet opening of the swirl chamber on the outlet face, and at least one or a plurality of feeder through-holes, with each feeder through-hole having an inlet opening on the inlet face and an outlet opening that opens into the swirl chamber so as to direct a fluid, flowing through the at least one feeder through-hole, to swirl or otherwise flow around a normal (e.g., a central or off center) axis of the swirl chamber, along the outer side wall and within the swirl chamber. That is, the outlet opening of the feeder through-hole opens into the swirl chamber such that a fluid flowing through the feeder through-hole and out its outlet opening is directed to flow around the central axis while the fluid is within the swirl chamber. The nozzle can include at least one or any combination of the following features:

(a) The swirl chamber is at least one groove, preferably an annular groove, defined by the bottom surface, the outer side wall and an inner side wall opposite the outer side wall that extends from the bottom surface toward the outlet side so as to form an inner periphery of the at least one outlet opening of the swirl chamber on the outlet face. In some embodiments, the portion of the nozzle structure that defines, at least in part, the inner side wall of the swirl chamber can be referred to as a central land or island portion. This central land or island portion can be seen as partially filling a blind hole swirl chamber.

(b) The nozzle has only one the swirl chamber.

(c) The nozzle is a monolithic single piece structure, and the outlet opening of the at least one feeder through-hole opens onto the outer side wall of the swirl chamber.

(d) The at least one feeder through-hole is configured so that the velocity of the fluid flowing into the at least one feeder through-hole is lower than the velocity of the fluid flowing out of the at least one feeder through-hole and into the swirl chamber (e.g., the cross-sectional area of the feeder through-hole can decrease when moving from its inlet opening to its outlet opening, the cross-sectional area of its inlet opening can be larger than that of its outlet opening, etc.).

(e) The nozzle further comprises a counterbore along the outlet opening of the swirl chamber between the outlet face and the outer side wall.

(f) The inlet opening of the at least one feeder through-hole is smaller in area than the outlet opening of the at least one feeder through-hole.

(g) The outlet opening of the at least one feeder through-hole opens onto the outer side wall of the swirl chamber, the at least one feeder through-hole has a through-hole central axis oriented so that fluid flowing out the at least one feeder through-hole is directed into the swirl chamber at an inclined direction towards the outlet opening of the swirl chamber on the outlet face of the nozzle and so as to flow around the outer side wall of said swirl chamber, before exiting the outlet opening of said swirl chamber.

(h) The outlet opening of the at least one feeder through-hole has a major dimension (i.e., a largest width or diameter), and the swirl chamber has a height in the range of from greater than the major dimension of the feeder through-hole outlet opening up to and including about two, three or four times the major dimension of the feeder through-hole outlet opening.

(i) Any combination of features (a) through (h).

The nozzle structure can be, e.g., a one-piece nozzle plate, a combination nozzle plate and valve guide that are either formed as one unitary structure or formed separately and joined together (e.g., by welding, etc.), or any other structure that has formed therein the swirl chamber and the one or more feeder through-holes. Such a nozzle can be used to supply any fluid (i.e., a liquid or gas) for a particular use in a given system and/or process. For example, the nozzle can be used as a fuel injector nozzle in supplying a liquid or gaseous fuel (e.g., gasoline, alcohol, methane, butane, propane, natural gas, etc.) into a combustion chamber of an internal combustion engine.
2. The nozzle of embodiment 1, wherein the nozzle is a fuel injector nozzle.
3. The nozzle of embodiment 1 or 2, wherein the nozzle is operatively adapted (i.e., dimensioned, configured or otherwise designed) for supplying a liquid fuel (e.g., gasoline, diesel, alcohol, fuel oil, jet fuel, urea, etc.) to a combustion chamber of an internal combustion engine.
4. The nozzle of embodiment 1 or 2, wherein the nozzle is operatively adapted (i.e., dimensioned, configured or otherwise designed) for supplying a gaseous fuel (e.g., natural gas, propane, butane, etc.) to a combustion chamber of an internal combustion engine.
5. The nozzle according to any one of embodiments 1 to 4, wherein the nozzle comprises a single piece nozzle structure (e.g., a nozzle plate or combination nozzle plate and valve guide) defined, at least in part, by the inlet face and the outlet face. The nozzle structures described herein may be constructed of any material or materials suitable for being used in nozzles, e.g., one of more metals, metal alloys, ceramics, etc. In one or more embodiments, a nozzle structure as described herein can be made, e.g., from electroplated metal, although other conventional additive metal manufacturing processes (e.g., metal particle sintering) may also be used.
6. The nozzle according to any one of embodiments 1 to 5, wherein the nozzle further comprises a valve guide (see, e.g., reference number 103 in FIG. 1B). The valve guide can be an integrally formed part of the nozzle, e.g., by using a multi-photon additive manufacturing process. Alternatively, when the nozzle includes a nozzle plate, the valve guide and nozzle plate can be joined, e.g., by being welded together.
7. The nozzle according to any one of embodiments 1 to 6, wherein the inlet face and outlet face are parallel to each other, at least around the periphery thereof (e.g., where it may be welded), within plus or minus about 0.5 or 1 degrees.
8. The nozzle according to any one of embodiments 1 to 6, wherein the inlet face and outlet face are parallel to each other, around the periphery thereof (e.g., where it may be welded) within plus or minus about 0.5 or 1 degrees.
9. The nozzle according to any one of embodiments 1 to 8, wherein at least one or both of the inlet and outlet faces have a three-dimensional curvature (see, e.g., FIGS. 25-28).
10. The nozzle according to any one of embodiments 1 to 9, wherein the at least one feeder through-hole is a plurality of feeder through-holes. For example, up to 8, 9, 10, 11, 12, 13, 14, 15, 16, or possibly more such feeder through-holes can be desirable.
11. The nozzle according to any one of embodiments 1 to 10, wherein the outlet opening of the at least one feeder through-hole opens into the swirl chamber so as to direct a fluid, flowing through the at least one feeder through-hole, along a through-hole axis that is tangential relative to the central axis where the through-hole axis intersects the outer side wall and wherein a projection of the through-hole axis onto the central axis forms an angle alpha between the central axis and the through-hole axis in the range of from 0 degrees, when the bottom surface is angled (see, e.g., FIGS. 31-33), or greater than 0 to less than 90 degrees (see, e.g., FIG. 2C) such that the fluid flowing into the swirl chamber has an axial component directing the fluid towards the outlet face of the nozzle structure.
12. The nozzle according to any one of embodiments 1 to 11, wherein the swirl chamber is a blind-hole defined only by the bottom surface and the outer side wall, and the outlet opening opens into the swirl chamber so as to direct a fluid, flowing through the at least one feeder through-hole, along a through-hole axis that is tangential relative to the central axis where the through-hole axis intersects the outer side wall and wherein a projection of the through-hole axis onto the central axis forms an angle alpha between the central axis and the through-hole axis in the range of from 0 degrees, when the bottom surface is angled (see, e.g., FIGS. 31-33), or greater than 0 to less than 90 degrees (see, e.g., FIG. 2C) such that the fluid flowing into the swirl chamber has an axial component directing the fluid towards the outlet face of the nozzle structure.
13. The nozzle of embodiment 12, wherein the outer side wall curves completely around the central axis (i.e., an axis located in the center of the bottom surface and extending generally or exactly perpendicularly out from the bottom surface and beyond the outlet face) of the blind-hole so the outlet opening has a circular, oval or otherwise annular shape.

14. The nozzle of embodiment 12, wherein the outer side wall comprises or is a series of flat planar wall segments connected side edge to side edge around the central axis of the blind-hole so the outlet opening has an outer periphery with at least a four-sided, and preferably an eight-sided or more polygonal shape.
15. The nozzle according to any one of embodiments 12 to 14, wherein the bottom surface of the blind-hole has a center point and a periphery adjacent to the outer side wall, and the center point is elevated above the periphery (i.e., the center point of the bottom surface is closer to the outlet face than its periphery). It may be desirable for the center point of the bottom surface to be lower than (i.e., its center point to be further from the outlet face) its periphery.
16. The nozzle of embodiment 15, wherein the bottom surface slopes up toward or down away from the outlet face from the periphery to the center point depending on whether the center point is elevated above the periphery or the center point is lower than the periphery, respectively.
17. The nozzle according to any one of embodiments 1 to 11, wherein the swirl chamber is at least one continuous annular groove or a plurality of discontinuous arcuate or linear grooves or trenches located within the thickness and defined at least in part by the bottom surface, the outer side wall and an inner side wall opposite the outer side wall and extending from the bottom surface toward the outlet side so as to form an inner periphery of the at least one arcuate outlet opening of the swirl chamber on the outlet face, and the outlet opening of each the feeder through-hole opens into the groove so as to direct a fluid, flowing through the feeder through-hole, along an axis having a first vector that intersects against at least one of, or both, the inner side wall and the outer side wall and a second vector that forms an angle with the bottom surface in the range of from 0, when the bottom surface is angled, or greater than 0 to less than 90 degrees.

As used herein, the term “annular” is defined as a circular shape, an oval shape, an otherwise curved shape, or an otherwise mostly curved shape (i.e., greater than 50%, 55%, 60%, 65%, 70%, 75%, 80%, 85%, 90%, or 95% of its length being curved), when viewing the outlet side of the nozzle.
18. The nozzle of embodiment 17, wherein at least one or both of the inner side wall and the outer side wall (a) curves completely around the central axis of the at least one groove (i.e., an axis located in the geometric center of the swirl chamber and extending generally or exactly perpendicularly out from the outlet face) so the portion of the outlet opening formed by the inner side wall, the outer side wall or both has an circular, oval or otherwise annular shape, (b) comprises or is formed by a series of flat planar wall segments connected side edge to side edge around the central axis of the at least one groove so the portion of the outlet opening formed by the inner side wall, the outer side wall or both has an outer periphery with at least a four-sided, and preferably an eight-sided or more polygonal shape, or (c) a combination of (a) and (b).
19. The nozzle of embodiment 17 or 18, wherein the at least one groove or trench is a continuous annular groove or trench.
20. The nozzle of embodiment 19, wherein the annular groove or trench has a continuous circular or oval shape.
21. The nozzle of embodiment 17 or 18, wherein the at least one groove or trench has a continuous polygonal shape.
22. The nozzle of embodiment 17 or 18, wherein the at least one groove or trench is a plurality of discontinuous arcuate or linear grooves or trenches spaced apart and generally disposed end-to-end.
23. The nozzle of embodiment 22, wherein the outlet opening of a least one feeder through-hole opens into each of the grooves or trenches such that fluid flowing through the at least one feeder through-hole swirls or otherwise flows around the central axis and along the outer side wall of the discontinuous groove or trench.
24. The nozzle of embodiment 22 or 23, wherein the discontinuous grooves or trenches comprise discontinuous arcuate or curved grooves or trenches that are spaced apart and disposed generally, mostly or exactly end-to-end relative to each other so as to at least generally form an annular groove or trench structure.
25. The nozzle according to any one of embodiment 17 to 24, wherein the bottom surface slopes up toward or down away from the outlet face, in the direction the fuel flows within the swirl chamber.
26. The nozzle according to any one of embodiments 17 to 25, wherein both the inner side wall and the outer side wall of each groove or trench form an angle with the outlet face that is in the range of from at least about 30° up to about 150°. or from at least about 45° up to about 135°.
27. The nozzle according to any one of embodiments 17 to 26, wherein both the inner side wall and the outer side wall of each groove or trench are angled away from or toward the central axis.
28. The nozzle according to any one of embodiments 17 to 26, wherein one of the inner side wall and the outer side wall of at least one the groove or trench is angled away from the central axis and the other of the inner side wall and the outer side wall is angled toward the central axis.
29. The nozzle according to any one of embodiments 1 to 28, wherein the outer side wall is angled away from the central axis.
30. The nozzle according to any one of embodiments 17 to 29, wherein the width of the at least one groove or trench (i.e., the distance between the inner side wall and the outer side wall) is in the range of from at least about 50, 60, 70, 80 90 or 100 micrometers up to and including about 110, 120, 130, 140, 150, or more micrometers. 31. The nozzle according to any one of embodiments 17 to 30, wherein the width of the at least one groove or trench remains the same from the bottom surface to the outlet face.
32. The nozzle according to any one of embodiments 17 to 30, wherein the width of the at least one groove or trench varies from the bottom surface to the outlet face (e.g., becomes wider or narrower from the bottom surface to the outlet face or alternates from becoming wider and narrower along the groove).
33. The nozzle according to any one of embodiments 1 to 32, wherein each feeder through-hole is operatively adapted (i.e., dimensioned, oriented and or otherwise configured) to direct a fluid flowing therethrough and out its outlet opening to flow along at least one side wall.
34. The nozzle according to any one of embodiments 17 to 26, wherein the outlet opening of at least one or a plurality of feeder through-holes, opens on the inner side wall.
35. The nozzle according to any one of embodiments 1 to 34, wherein the outlet opening of at least one or a plurality of feeder through-holes, opens on the outer side wall.
36. The nozzle according to any one of embodiments 1 to 35, wherein the outlet opening of at least one or a plurality of feeder through-holes, opens on the bottom surface.
37. The nozzle according to any one of embodiments 1 to 36, wherein the at least one feeder through-hole is a plurality of the feeder through-holes.
38. The nozzle of embodiment 37, wherein the outlet openings of the feeder through-holes open at spaced apart locations around the swirl chamber (e.g., along the circumference of the blind hole or annular groove).
39. The nozzle of embodiment 37 or 38, wherein outlet openings of a plurality of the feeder through-holes open at different depths within the swirl chamber.
40. The nozzle according to any one of embodiments 37 to 39, wherein the outlet openings of the feeder through-holes open at equally spaced apart locations within the swirl chamber.
41. The nozzle according to any one of embodiments 1 to 40, further comprising a counterbore along the outlet opening of the swirl chamber between the outlet face and the outer side wall.
42. The nozzle according to any one of embodiments 17 to 32 and 34, further comprising a counterbore along the outlet opening of the at least one groove or trench between the outlet face and the inner side wall.
43. The nozzle of embodiment 42, further comprising a counterbore along the outlet opening of the at least one groove or trench between the outlet face and the outer side wall.
44. The nozzle according to any one of embodiments 1 to 43, wherein fluid flowing into the swirl chamber, from the at least one feeder through-hole, exits the swirl chamber in the form of a funnel-shaped fluid plume having an initial tubular-shaped or otherwise cylinder-shaped portion, which is completely, mostly or at least partially located within the swirl chamber, and a cone-shaped portion located outside the swirl chamber and extending from the initial tubular-shaped or otherwise cylinder-shaped portion.
45. The nozzle according to any one of embodiments 1 to 44 comprising multiple of the swirl chamber.
46. The nozzle according to any one of embodiments 1 to 45, wherein the nozzle has a normal axis that is not parallel to the central axis of each the swirl chamber.
47. The nozzle according to any one of the embodiments 1 to 46, wherein the swirl chamber is at least one groove defined by the bottom surface, the outer side wall and an inner side wall opposite the outer side wall that extends from the bottom surface toward the outlet side so as to form an inner periphery of the at least one outlet opening of the swirl chamber on the outlet face, the outlet opening of the at least one feeder through-hole has a major dimension (i.e., a largest width or diameter), and the distance between the inner side wall and the outer side wall is less than the major dimension of the outlet opening of the at least one feeder through-hole.
48. A fuel injector spray pattern having a funnel shape comprising an initial tubular- shaped or otherwise cylinder-shaped portion, and a cone-shaped portion extending from the initial tubular-shaped or otherwise cylinder-shaped portion.
49. A method of making a funnel shaped fuel injector spray pattern, said method comprising using a fuel injector nozzle according to any one of embodiments 1 to 47 to form the funnel shape fuel injector spray pattern, wherein the funnel shaped fuel injector spray pattern comprises an initial tubular-shaped or otherwise cylinder-shaped portion, and a cone-shaped portion extending from the initial tubular-shaped or otherwise cylinder-shaped portion.
50. A fuel injector comprising a nozzle according to any one of embodiments 1 to 47.
51. A fuel system comprising the fuel injector of embodiment 50.
52. An internal combustion engine comprising the fuel system of embodiment 50.
53. The internal combustion engine of embodiment 52 being a gasoline direct injection engine.

This invention is not limited to the above-described embodiments but is to be controlled by the limitations set forth in the following claims and any equivalents thereof. This invention may be suitably practiced in the absence of any element not specifically disclosed herein. It is also within the teachings and scope of this invention for the various supply port (e.g., swirl chamber and feeder through-hole) structural features to be interchangeable between embodiments. For example, different types of feeder through-holes could be used in the same supply port design.

All patents and patent applications cited above, including those in the Background section, are incorporated by reference into this document in total.

1. A fuel injector nozzle structure comprising an inlet face on an inlet side, an outlet face on an outlet side, a thickness between said inlet face and said outlet face, and at least one fluid supply port comprising:
a swirl chamber located within said thickness, with said swirl chamber comprising a bottom surface and an outer side wall extending from said bottom surface toward said outlet side so as to form an outer periphery of an outlet opening of said swirl chamber on said outlet face; and
at least one feeder through-hole having an inlet opening on said inlet face and an outlet opening that opens into said swirl chamber so as to direct a fluid, flowing through said at least one feeder through-hole, to flow around a central axis of said swirl chamber, along said outer side wall and within said swirl chamber,
wherein either (a) said swirl chamber is at least one groove defined by said bottom surface, said outer side wall and an inner side wall opposite said outer side wall that extends from said bottom surface toward said outlet side so as to form an inner periphery of said at least one outlet opening of said swirl chamber on said outlet face, (b) the outlet opening of said at least one feeder through-hole opens onto the outer side wall of said swirl chamber, and said at least one feeder through-hole has a through-hole central axis oriented so that fluid flowing out of the outlet opening of said at least one feeder through-hole is directed into said swirl chamber at an inclined direction towards the outlet opening of said swirl chamber and so as to flow around the outer side wall of said swirl chamber, before exiting the outlet opening of said swirl chamber, or (c) both (a) and (b).

2. The nozzle structure of claim 1, wherein said nozzle structure has only one said swirl chamber.

3. The nozzle structure of claim 1, wherein said nozzle structure is a monolithic single piece structure, and the outlet opening of said at least one feeder through- hole opens onto the outer side wall of said swirl chamber.

4. The nozzle structure according to claim 1, wherein said at least one feeder through-hole is configured so that the velocity of the fluid flowing into said at least one feeder through-hole is lower than the velocity of the fluid flowing out of said at least one feeder through-hole and into said swirl chamber.

5. The nozzle structure according to any onc of claim 1, wherein the inlet opening of said at least one feeder through-hole is smaller in area than the outlet opening of said at least one feeder through-hole,

6. The nozzle structure according to any onc of claim 1, wherein the outlet opening of said at least one feeder through-hole has a major dimension, and said swirl chamber has a height in the range of from greater than the major dimension of the feeder through-hole outlet opening up to and including about three times the major dimension of the feeder through-hole outlet opening.

7. The nozzle structure according to any one of claim 1, wherein said swirl chamber is a blind-hole defined by said bottom surface and said outer side wall, the outlet opening of said at least one feeder through-hole opens onto the outer side wall of said swirl chamber, and said at least one feeder through-hole has a through-hole central axis oriented so that fluid flowing out of the outlet opening of said at least one feeder through-hole is directed into said swirl chamber at an inclined direction towards the outlet opening of said swirl chamber and so as to flow around the outer side wall of said swirl chamber, before exiting the outlet opening of said swirl chamber.

8. The nozzle structure of claim 7, wherein the bottom surface of said blind-hole has a center point and a periphery adjacent to said outer side wall, and the bottom surface slopes up toward or down away from said outlet face from the periphery to the center point.

9. The nozzle structure according to claim 1, wherein said swirl chamber is at least one groove located within said thickness and defined by said bottom surface, said outer side wall and an inner side wall opposite said outer side wall and extending from said bottom surface to said outlet side so as to form an inner periphery of said at least one outlet opening of said swirl chamber on said outlet face.

10. The nozzle structure of claim 9, wherein said at least one groove is a continuous annular groove.

11. The nozzle structure according to claim 9, wherein the width of said at least one groove varies from said bottom surface to said outlet face.

12. The nozzle structure according to claim 1, further comprising a counterbore along the outlet opening of said swirl chamber between said outlet face and said outer side wall.

13. The nozzle structure according to claim 9, further comprising a counterbore along the outlet opening of said at least one groove between said outlet face and at least one of said inner side wall and said outer side wall.

14. The nozzle structure according to claim 1, wherein fluid flowing into said swirl chamber, from said at least one feeder through-hole, exits said swirl chamber in the form of a funnel-shaped fluid plume having an initial cylinder-shaped portion at least partially located within the swirl chamber, and a cone-shaped portion located outside said swirl chamber and extending from said initial cylinder-shaped portion.

15. The nozzle structure according to claim 1, wherein the outlet face of said nozzle has a normal axis that is not parallel to the central axis of each said swirl chamber.

16. A fuel injector spray pattern having a funnel shape comprising an initial tubular-shaped or otherwise cylinder-shaped portion, and a cone-shaped portion extending from the initial tubular-shaped or otherwise cylinder-shaped portion.

17. A method of making a funnel shaped fuel injector spray pattern, said method comprising using a fuel injector nozzle according to claim 1 to form the funnel shape fuel injector spray pattern, wherein the funnel shaped fuel injector spray pattern comprises an initial tubular-shaped or otherwise cylinder-shaped portion, and a cone-shaped portion extending from the initial tubular-shaped or otherwise cylinder-shaped portion.

18. A fuel injector comprising a nozzle structure according to claim 1.

19. A fuel system comprising the fuel injector of claim 18.

20. An internal combustion engine comprising the fuel system of claim 19.
